(19) United States
(12) Patent Application Publication
(10) Pub. No.: US 2007/0073439 A1
(43) Pub. Date: Mar. 29, 2007

(54) SYSTEM AND METHOD OF VISUAL TRACKING

(76) Inventors: Babak Habibi, North Vancouver, BC (CA); Geoffrey C. Clark, Vancouver, BC (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/534,578

(22) Filed: Sep. 22, 2006

Related U.S. Application Data
(60) Provisional application No. 60/719,765, filed on Sep. 23, 2005.

(51) Int. Cl. G06F 7/00

(52) U.S. Cl. 700/213

(57) ABSTRACT

A machine-vision system, method and article is useful in the field of robotics. One embodiment produces signals that emulate the output of an encoder, based on captured images of an object, which may be in motion. One embodiment provides digital data directly to a robot controller without the use of an intermediary transceiver such as an encoder interface card. One embodiment predicts or determines the occurrence of an occlusion and moves at least one of a camera and/or the object accordingly.

### CROSS-REFERENCE TO RELATED APPLICATIONS

This application claims benefit under 35 U.S.C. 119(e) to U.S. provisional patent application Ser. No. 60/719,765, filed Sep. 23, 2005.

### BACKGROUND OF THE INVENTION

1. Field of the Invention

This disclosure generally relates to machine vision, and more particularly, to visual tracking systems using image capture devices.

2. Description of the Related Art

Robotic systems have become increasingly important in a variety of manufacturing and device assembly processes. Robotic systems typically employ a mechanical device, commonly referred to as a manipulator, to move a working device or tool, called an end effector hereinafter, in proximity to a workpiece that is being operated upon. For example, the workpiece may be an automobile that is being assembled, and the end effector may be a bolt, screw or nut driving device used for attaching various parts to the automobile.

In assembly line systems, the workpiece moves along a conveyor track, or along another parts-moving system, so that a series of workpieces may have the same or similar operations performed on them when they are at a common place along the assembly line. In some systems, the workpieces may be moved to a designated position along the assembly line and remain stationary while the operation is being performed on the workpiece by a robotic system. In other systems, the workpiece may be continually moving along the assembly line as work is being performed on the workpiece by the robotic system.

As a simplified example, consider the case of automobile manufacture. Automobiles are typically assembled on an assembly line. A robotic system could automatically attach parts to the automobile at predefined points along the assembly line. For example, the robotic system could attach a wheel to the automobile. Accordingly, the robotic system would be configured to orient a wheel nut into alignment with a wheel bolt, and then rotate the wheel nut in a manner that couples the wheel nut to the wheel bolt, thereby attaching the wheel to the automobile.

The robotic system could be further configured to attach all of the wheel nuts to the wheel bolts for a single wheel, thereby completing attachment of one of the wheels to the automobile. Further, the robotic system could be configured, after attaching the front wheel (assuming that the automobile is oriented in a forward facing direction as the automobile moves along the assembly line) to then attach the rear wheel to the automobile. In a more complex assembly line system, the robot could be configured to move to the other side of the automobile and attach wheels to the opposing side of the automobile.

In the above-described simplified example, the end effector includes a socket configured to accept the wheel nut and a rotating mechanism which rotates the wheel nut about the wheel bolt. In other exemplary applications, the end effector could be any suitable working device or tool, such as a welding device, a spray paint device, a crimping device, etc. In the above-described simplified example, the workpiece is an automobile. Examples of other types of workpieces include electronic devices, packages, or other vehicles including motorcycles, airplanes or boats. In other situations, the workpiece may remain stationary and a plurality of robotic systems may be operating sequentially and/or concurrently on the workpiece. It is appreciated that the variety of, and variations to, robotic systems, end effectors and their operations on a workpiece are limitless.

In various conveyor systems commonly used in assembly line processes, accurately and reliably tracking position of the workpiece as it is transported along the assembly line is a critical factor if the robotic system is to properly orient its end effector in position to the workpiece. One prior art method of tracking position of a workpiece moving along an assembly line is to relate the position of the workpiece with respect to a known reference point. For example, the workpiece could be placed in a predefined position and/or orientation on a conveyor track, such that the relationship to the reference point is known. The reference point may be mark or a guide disposed on, for example, the conveyor track itself.

Movement of the conveyor track may be monitored by a conventional encoder. For example, movement may be monitored using shaft or rotational encoders or linear encoders, which may take the form of incremental encoders or absolute encoders. The shaft or rotational encoder may track rotational movement of a shaft. If the shaft is used as part of the conveyor track drive system, or is placed in frictional contact with the conveyor track such that the shaft is rotated by track movement, the encoder output may be used to determine track movement. That is, the angular amount of shaft rotation is related to linear movement of the conveyor track (wherein one rotation of the shaft corresponds to one unit of traveled linear distance).

Encoder output is typically an electrical signal. For example, encoder output may take the form of one or more analog signal waveforms, for instance one or more square wave voltage signals or sine wave signals, wherein the frequency of the output square wave signals are proportional to conveyor track speed. Other encoder output signals corresponding to track speed may be provided by other types of encoders. For example, absolute encoders may produce a binary word.

The encoder output signal is communicated to a translating device that is configured to receive the shaft encoder output signal, and generate a corresponding signal that is suitable for the processing system of a robot controller. For example, the output of the encoder may be an electrical signal that may be characterized as an analog square wave having a known high voltage (+V) and a known low voltage (−V or 0). Input to the digital processing system is typically not configured to accept an analog square wave voltage signal. The digital processing system typically requires a digital signal, which is likely to have a much different voltage level than the analog square wave voltage signal provided by the encoder. Thus, the translator is configured to generate an output signal, based upon the input analog square wave voltage signal for the encoder, having a digital format suitable for the digital processing system.

Other types of electromechanical devices may be used to monitor movement of the conveyor track. Such devices detect some physical attribute of conveyor track movement, and then generate an output signal corresponding to the detected conveyor track movement. Then, a translator generates a suitable digital signal corresponding to the generated output signal, and communicates the digital signal to the processing system of the robot controller.

The digital processing system of the robot controller, based upon the digital signal received from the translator, is able to computationally determine velocity (a speed and direction vector) and/or acceleration of the conveyor track based upon the output of the shaft encoder or other electromechanical device. In other systems, such computations are performed by the translator. For example, if the generated output square wave voltage signal is proportional to track speed, then a simple multiplication of frequency by a known conversion factor results in computation of conveyor track velocity. Changes in frequency, which can be computationally related to changes in conveyor track velocity, allows computation of conveyor track acceleration. In some devices, directional information may be determined from a plurality of generated square wave signals. Knowing the conveyor track velocity (and/or acceleration) over a fixed time period allows computation of distance traveled by a point on the conveyor track.

As noted above, a reference point is used to define the position and/or orientation of the workpiece on the conveyor track. When the moving reference point is synchronized with a fixed reference point having a known position, the processing system is able to computationally determine the position of the workpiece in a known workspace geometry.

For example, as the reference point moves past the fixed point, the processing system may then computationally define that position of the reference point as the zero point or other suitable reference value in the workspace geometry. For example, in a one-dimensional workspace geometry that is tracking linear movement of the conveyor track along a defined “x” axis, the position where the moving reference point aligns with the fixed reference point may be defined as zero or another suitable reference value. As time progresses, since conveyor track velocity and/or acceleration is known, position of the reference point with respect to the fixed point is determinable.

That is, as the reference point is moving along the path of the conveyor track, position of the reference point in the workspace geometry is determinable by the robot controller. Since the relationship of the workpiece to the reference point is known, position of the workpiece in the workspace geometry is also determinable. For example, in a workspace geometry defined by a Cartesian coordinate system (x, y and z coordinates), the position of the reference point may be defined as 0,0,0. Thus, any point of the workpiece may be defined with respect to the 0,0,0 position of the workspace geometry.

Accordingly, the robotic controller may computationally determine the position and/or orientation of its end effector relative to any point on the workpiece as the workpiece is moving along the conveyor track. Such computational methods used by various robotic systems are well known and are not described in greater detail herein.

Once the conveyor system has been set up, the conveyor track position detecting systems (e.g., encoder or other electromechanical devices) have been installed, the robotic system(s) has been positioned in a desired location along the assembly line, the various workspace geometries have been defined, and the desired work process has been learned by the robot controller, the entire system may be calibrated and initialized such that the robotic system controller may accurately and reliably determine position of the workpiece and the robot system end effector relative to each other. Then, the robot controller can align and/or orient the end effector with a work area on the workpiece such that the desired work may be performed. Often, the robot controller also controls operation of the device or tool of the end effector. For example, in the above-described example where the end effector is a socket designed to drive a wheel nut onto a wheel bolt, the robot controller would also control operation of the socket rotation device.

Several problems are encountered in such complex assembly line systems and robotic systems. Because the systems are complex, the process of initially initializing and calibrating an assembly line system and a robotic system is very time consuming. Accordingly, changing the assembly line process is relatively difficult. For example, characteristics of the workpiece may vary over time. Or, the workpieces may change. Each time such a change is made, the robotic system must be re-initialized to track the workpiece as it moves through the workspace geometry.

In some instances, changes in the conveyor system itself may occur. For example, if a different type of workpiece is to be operated on by the robotic system, the conveyor track layout may be modified to accommodate the new workpiece. Thus, one or more shaft encoders or other electro-mechanical devices may be added to or removed from the system. Or, after failure, a shaft encoder or other electromechanical device may have to be replaced. As yet another example, a more advanced or different type of shaft encoder or other electro-mechanical device may be added to the conveyor system as an upgrade. Adding and/or replacing a shaft encoder or other electro-mechanical device is time consuming and complex.

Additionally, various error-causing effects may occur over time as a series of workpieces are transported by the conveyor system. For example, there may be slippage of the conveyor track over the track transport system. Or, the conveyor track may stretch or otherwise deform. Or, if the conveyor system is mounted on wheels, rollers or the like, the conveyor system may itself be moved out of position during the assembly process. Accordingly, the entire system will no longer be properly calibrated. In many instances, small incremental changes by themselves may not be significant enough to cause a tracking problem. However, the effect of such small changes may be cumulative. That is, the effect of a number of small changes in the physical system may accumulate over time such that, at some point, the system falls out of calibration. When the ability to accurately and reliably track the workpiece and/or the end effector is degraded or lost because the system falls out of calibration, the robotic process may misoperate or even fail.

Thus, it is desirable to be able to avoid the above-described problems which may cause the system to fall out of calibration and instead directly determine the position of the workpiece relative to the workspace geometry. Also, it may be desirable to be able to conveniently modify the conveyor system, which may involve replacing the shaft encoders or other electromechanical devices.

Machine vision systems have been configured to provide visual-based information to a robotic system so that the robot controller may accurately and reliably determine position of the workpiece and the robot system end effector relative to each other, and accordingly, cause the end effector to align and/or orient the end effector with the work area on the workpiece such that the desired work may be performed.

However, it is possible for portions of the robot system to block the view of the image capture device used by the vision system. For example, a portion of a robot arm, referred to herein as a manipulator, may block the image capture device's view of the workpiece and/or the end effector. Such occlusions are undesirable since the ability to track the workpiece and/or the end effector may be degraded or completely lost. When the ability to accurately and reliably track the workpiece and/or the end effector is degraded or lost, the robotic process may misoperate or even fail. Accordingly, it is desirable to avoid occlusions of the workpiece and/or the end effector.

Additionally, if the vision system employs a fixed position image capture device to view the workpiece, the detected image of the workpiece may move out of focus as the workpiece moves along the conveyor track. Furthermore, if the image capture device is affixed to a portion of a manipulator of the robot system, the detected image of the workpiece may move out of focus as the end effector moves towards the workpiece. Accordingly, complex automatic focusing systems or graphical imaging systems are required to maintain focus of the images captured by the image capture device. Thus, it is desirable to maintain focus without the added complexity of automatic focusing systems or graphical imaging systems.

### BRIEF SUMMARY OF THE INVENTION

One embodiment takes advantage of intermediary transducers currently employed in robotic control to eliminate reliance on shaft or rotational encoders. Such intermediary transducers typically take the form of specialized add-on cards that are inserted in a slot or otherwise directly communicatively coupled to a robot controller. The intermediary transducer has analog inputs designed to receive analog encoder formatted information. This analog encoder formatted information is the output typically produced by shaft, rotational encoders (e.g., single channel, one dimensional) or other electromechanical movement detection systems.

As discussed above, output of a shaft or rotational encoder may typically take the form of one or more pulsed voltage signals. In an exemplary disclosed embodiment, the intermediary controller continues to operate as a mini-preprocessor, converting analog information in an encoder type format into a digital form suitable for the robot controller. In the disclosed embodiment, the vision tracking system converts machine-vision information into analog encoder type formatted information, and supplies such to the intermediary transducer. This embodiment advantageously emulates output of the shaft or rotational encoder, allowing continued use of existing installations or platforms of robot controllers with intermediary transducers, such as, but not limited to, a specialized add-on card.

Another exemplary embodiment advantageously eliminates the intermediary transducer or specialized add-on card that performs the preprocessing that transforms the analog encoder formatted information into digital information for the robot controller. In such an embodiment, the vision tracking system employs machine-vision to determine the position, velocity and/or acceleration, and passes digital information indicative of such determined parameters directly to a robot controller, without the need for an intermediary transducer.

In a further embodiment, the vision tracking system advantageously addresses the problems of occlusion and/or focus by controlling the position and/or orientation of one or more cameras independently of the robotic device. While robot controllers typically can manage up to thirty-six (36) axes of movement, often only six (6) axes are used. The disclosed embodiments advantageously take advantage of such by using some of the otherwise unused functionality of the robot controller to control movement (translation and/or orientation or rotation) of one or more cameras. The position or orientation of the camera may be separately controlled, for example via a camera control. Controlling the position and orientation of the camera may allow control over the field-of-view (position and size). The camera may be treated as just another axis of movement, since existing robotic systems have many channels for handling many axes of freedom.

The position and/or orientation of the image capture device(s) (cameras) may be controlled to avoid or reduce the incidence of occlusion, for example where at least a portion of the robotic device would either partially or completely block part of the field of view of the camera, thereby interfering with detection of a feature associated with a workpiece. Additionally, or alternatively, the position and/or orientation of the camera(s) may be controlled to maintain the field of view at a desired size or area, thereby avoiding having too narrow a field of view as the object (or feature) approaches the camera and/or avoiding loss of line of sight to desired features on workpiece. Additionally, or alternatively, the position and/or orientation of the camera(s) may be controlled to maintain focus on an object (or feature) as the object moves, advantageously eliminating the need for expensive and complicated focusing mechanisms.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a perspective view of a vision tracking system tracking a workpiece on a conveyor system and generating an emulated output signal.

FIG. 2 is a perspective view of a vision tracking system tracking a workpiece on a conveyor system and generating an emulated processor signal.

FIG. 3 is a block diagram of a processor system employed by embodiments of the vision tracking system.

FIG. 4 is a perspective view of a simplified robotic device.

FIGS. 5A-C are perspective views of an exemplary vision tracking system embodiment tracking a workpiece on a conveyor system when a robot device causes an occlusion.

FIGS. 6A-D are perspective views of various image capture devices used by vision tracking system embodiments.

FIG. 7 is a flowchart illustrating an embodiment of a process for emulating the output of an electromechanical movement detection system such as a shaft encoder.

FIG. 8 is a flowchart illustrating an embodiment of a process for generating an output signal that is communicated to a robot controller.

FIG. 9 is a flowchart illustrating an embodiment of a process for moving position of the image capture device so that the position is approximately maintained relative to the movement of workpiece.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with machine vision systems, robots, robot controllers, an communications channels, for example, communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

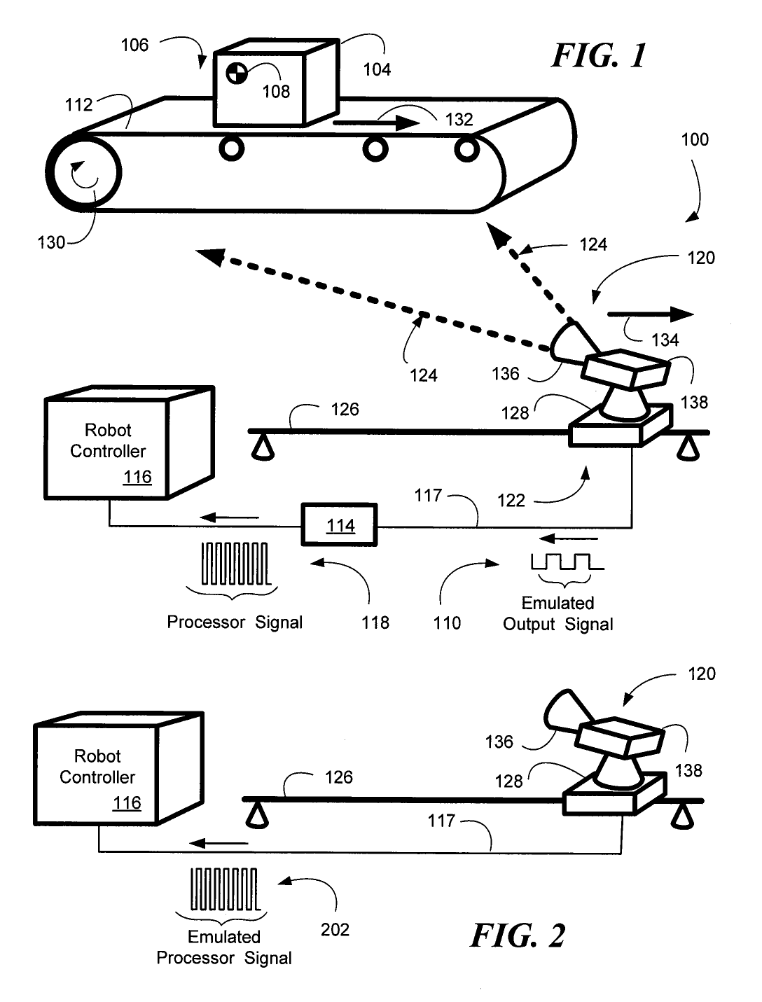

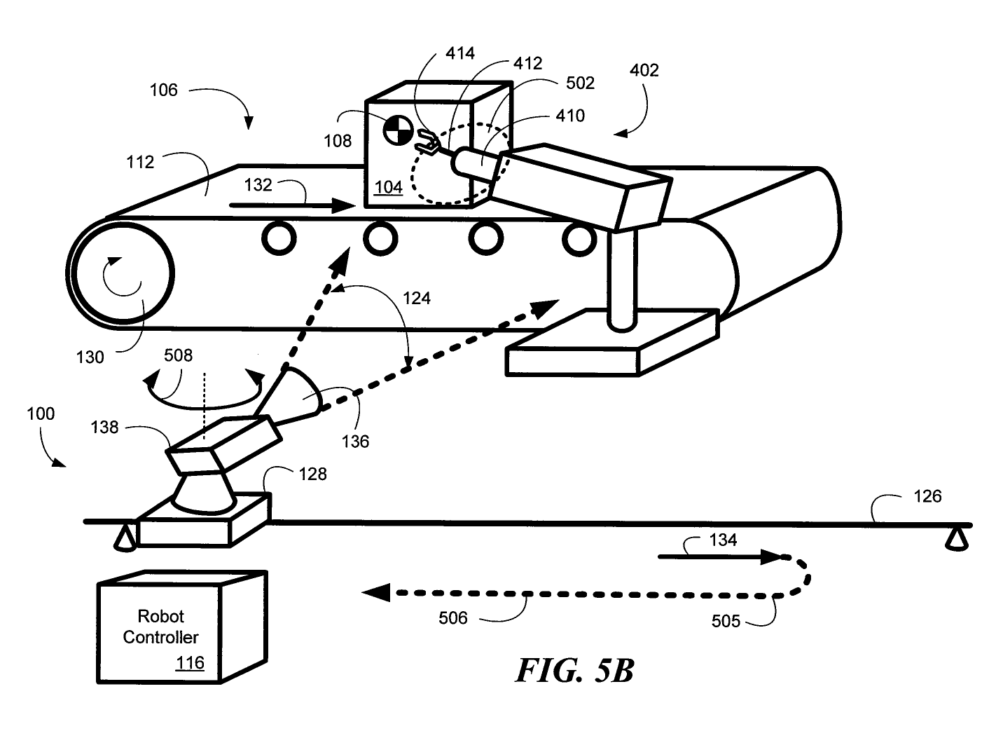

Various embodiments of the vision tracking system 100 (FIGS. 1-6) provide a system and method for visually tracking a workpiece 104, or portions thereof, while a robotic device 402 (FIG. 4) performs a work task on or is in proximity to the workpiece 104 or portions thereof. Accordingly, embodiments of the vision tracking system 100 provide a system and method of data collection pertaining to at least the velocity (i.e., speed and direction) of the workpiece 104 such that position of the workpiece 104 and/or an end effector 414 of a robotic device 402 are determinable. Such a system may advantageously eliminate the need for shaft or rotational encoders or the like, or restrict the use of such encoders to providing redundancy. The vision tracking system 100 detects movement of one or more visibly discernable features 108 on a workpiece 104 as the workpiece 104 is being transported along a conveyor system 106.

One embodiment takes advantage of intermediary transducers 114 currently employed in robotic control to eliminate reliance on shaft or rotational encoders. Such intermediary transducers 114 typically take the form of specialized add-on cards that are inserted in a slot or otherwise directly communicatively coupled to a robot controller 116. The intermediary transducer 114 has analog inputs designed to receive the output, such as an analog encoder formatted information, typically produced by shaft, rotational encoders (e.g., single channel, one dimensional) or other electromechanical movement detection systems. As discussed above, output of a shaft or rotational encoder may typically take the form of one or more pulsed voltage signals. In an exemplary embodiment, the intermediary controller 114 continues to operate as a mini-preprocessor, converting the received analog information in an encoder type format into a digital form suitable for a processing system of the robot controller 116. In the disclosed embodiment, the vision tracking system 100 converts machine-vision information into analog encoder type formatted information, and supplies such to the intermediary transducer 114. This approach advantageously emulates the shaft or rotational encoder, allowing continued use of existing installations or platforms of robot controllers with specialized add-on card.

Another embodiment advantageously eliminates the intermediary transducer 114 that performs the preprocessing that transforms the analog encoder formatted information into digital information for the robot controller 116. In such an embodiment, the vision tracking system 100 employs machine-vision to determine the position, velocity and/or acceleration, and passes digital information indicative of such determined parameters directly to a robot controller 116, without the need for an intermediary transducer.

In a further embodiment, the vision tracking system 100 advantageously addresses the problems of occlusion and/or focus by controlling the position and/or orientation of one or more image capture devices 120 (cameras) independently of the robotic device 402. While robot controllers 116 typically can manage up to 36 axes of movement, often only 6 axes are used. The disclosed embodiment advantageously takes advantage of such by using some of the otherwise unused functionality of the robot controller 116 to control movement (translation and/or orientation or rotation) of one or more cameras.

The position and/or orientation of the camera(s) 120 may be controlled to avoid or reduce the incidence of occlusion, for example where at least a portion of the robotic device 402 would either partially or completely block part of the field of view of the camera thereby interfering with detection of a feature 108 associated with a workpiece 104. Additionally, or alternatively, the position and/or orientation the camera(s) 120 may be controlled to maintain the field of view at a desired size or area, thereby avoiding having too narrow a field of view as the object approaches the camera. Additionally, or alternatively, the position and/or orientation of the camera(s) 120 may be controlled to maintain focus on an object (or feature) as the object moves, advantageously eliminating the need for expensive and complicated focusing mechanisms.

Accordingly, the vision tracking system 100 uses an image capture device 120 to track a workpiece 104 to avoid, or at least minimize the impact of, occlusions caused by a robotic device 402 (FIG. 4) and/or other objects as the workpiece 104 is being transported by a conveyor system 106.

FIG. 1 is a perspective view of a vision tracking system 100 tracking a workpiece 104 on a conveyor system 106 and generating an emulated output signal 110. The vision tracking system 100 tracks movement of a feature of the workpiece 104 such as feature 108, using machine-vision techniques, and computationally determines an emulated encoder output signal 110. Alternatively, the vision tracking system 100 may be configured to track movement of the belt 112 or another component whose movement is relatable to the speed of the belt 112 and/or workpiece 104 using machine-vision techniques, and to determine an emulated encoder output signal 110.

The emulated output signal 110 is communicated to a transducer 114, such as a card or the like, which may, for example reside in the robot controller 116, or which may reside elsewhere. The transducer 114 has analog inputs designed to receive the output typically produced by shaft or rotational encoders (e.g., single channel, one dimensional). Transducer 114 preprocesses the emulated encoder signal 110 as if it were an actual encoder signal produced by a shaft or rotational encoder, and outputs a corresponding processor signal 118 suitable for a processing system of the robotic controller 116. This approach advantageously emulates the shaft or rotational encoder, allowing continued use of existing installations or platforms of robot controllers with specialized add-on card. The output of any electromechanical motion detection device may be emulated by various embodiments.

The vision tracking system 100 comprises an image capture device 120 (also referred to herein as a camera). Some embodiments may comprise an image capture device positioning system 122. The image capture device positioning system 122, also referred to herein as the positioning system 122, is configured to adjust a position of the image capture device 120. When tracking, the position of the image capture device 120 is approximately maintained relative to the movement of workpiece 104. In response to occlusion events, the position of the image capture device 120 will be adjusted to avoid or mitigate the effect of occlusion events. Such occlusion events, described in greater detail hereinbelow, may be caused by a robotic device 402 or another object which is blocking at least a portion of the image capture device 120 field of view 124 (as generally denoted by the dashed arrows for convenience).

In the embodiment of the vision tracking system 100 illustrated in FIG. 1, a track 126 is coupled to the image capture device base 128. Base 128 may be coupled to the image capture device 120, or may be part of the image capture device 120, depending upon the embodiment. Base 128 includes moving means (not shown) such that the base 128 may be moved along the image capture device track 126. Accordingly, position of the image capture device 120 relative to the workpiece 104 is adjustable.

To demonstrate some of the principles of operation of one or more selected embodiments of a vision tracking system 100, an exemplary workpiece 104 being transported by the conveyor system 106 is illustrated in FIG. 1. The workpiece 104 includes at least one visual feature 108, such as a cue. Visual feature 108 is visually detectable by the image capture device 120. It is appreciated that any suitable visual features(s) 108 may be used. For example, visual feature 108 may be a symbol or the like that is applied to the surface of the workpiece 104 using a suitable ink, dye, paint or the like. Or, the visual feature 108 may be a physical marker that is temporarily attached, or permanently attached, to the workpiece 104.

In some embodiments, the visual feature 108 may be a determinable characteristic of the workpiece 104 itself, such as a surface edge, slot, hole, protrusion, angle or the like. Identification of the visual characteristic of a feature 108 is determined from information captured by the image capture device 120 using any suitable feature determination algorithm which analyzes captured image information.

In other embodiments, the visual feature 108 may not be visible to the human eye, but rather, visible only to the image capture device 120. For example, the visual feature 108 may use paint or the like that emits an infrared, ultraviolet or other energy spectrum that is detectable by the image capture device 120.

The simplified conveyor system 106 includes at least a belt 112, a belt drive device 130 (alternatively referred to herein as the belt driver 130) and a shaft encoder. As the belt driver 130 is rotated by a motor or the like (not shown), the belt 112 is advanced in the direction indicated by the arrow 132. Since the workpiece 104 is resting on, or is attached to, the belt 112, the workpiece 104 advances along with the belt 112.

It is appreciated that any suitable conveyor system 106 may be used to advance the workpiece 104 along an assembly line. For example, racks or holders moving on a track device could be used to advance the workpiece 104 along an assembly line. Furthermore, with this simplified example illustrated in FIG. 1, the direction of transport of the workpiece 104 is in a single, linear direction (denoted by the directional arrow 132). The direction of transport need not be linear. The transport path could be curvilinear or another predefined transport path based upon design of the conveyor system. Additionally, or alternatively, the transport path may move in one direction at a first time and a second direction at a second time (e.g., forwards, then backwards).

As the workpiece 104 is advanced along the transport path defined by the nature of the conveyor system 106 (here, a linear path as indicated by the directional arrow 132), the image capture device 120 is concurrently moved along the track 126 at approximately the same velocity (a speed and direction vector) as the workpiece 104, as denoted by the arrow 134. That is, the relative position of the image capture device 120 with respect to the workpiece 104 is approximately constant.

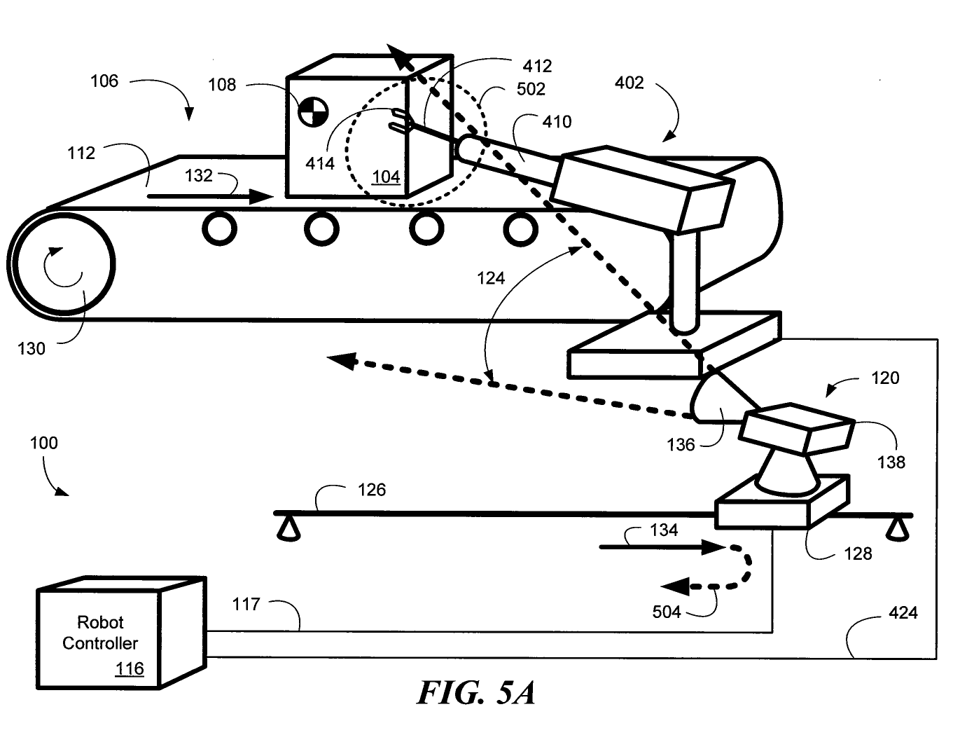

For convenience, the image capture device 120 includes a lens 136 and an image capture device body 138. The body 138 is attached to the base 128. A processor system 300 (FIG. 3), in various embodiments, may reside in the body 138 or the base 128.

As noted above, various conventional electromechanical movement detection devices, such as shaft or rotational encoders, generate output signals corresponding to movement of belt 112. For example, a shaft encoder may generate one or more output square wave voltage signals or the like which would be communicated to the transducer 114. The above-described emulated output signal 110 replaces the signal that would be otherwise communicated to the transducer 118 by the shaft encoder. Accordingly, the electromechanical devices, such as shaft encoders or the like, are no longer required to determine position, velocity and/or acceleration information. While not required in some embodiments, shaft encoders and the like may be employed for providing redundancy or other functionality.

Transducer 114 is illustrated as a separate component remote from the robot controller 116 for convenience. In various systems, the transducer 114 may reside within the robot controller 116, such as an insertable card or like device, and may even be an integral part of the robot controller 116.

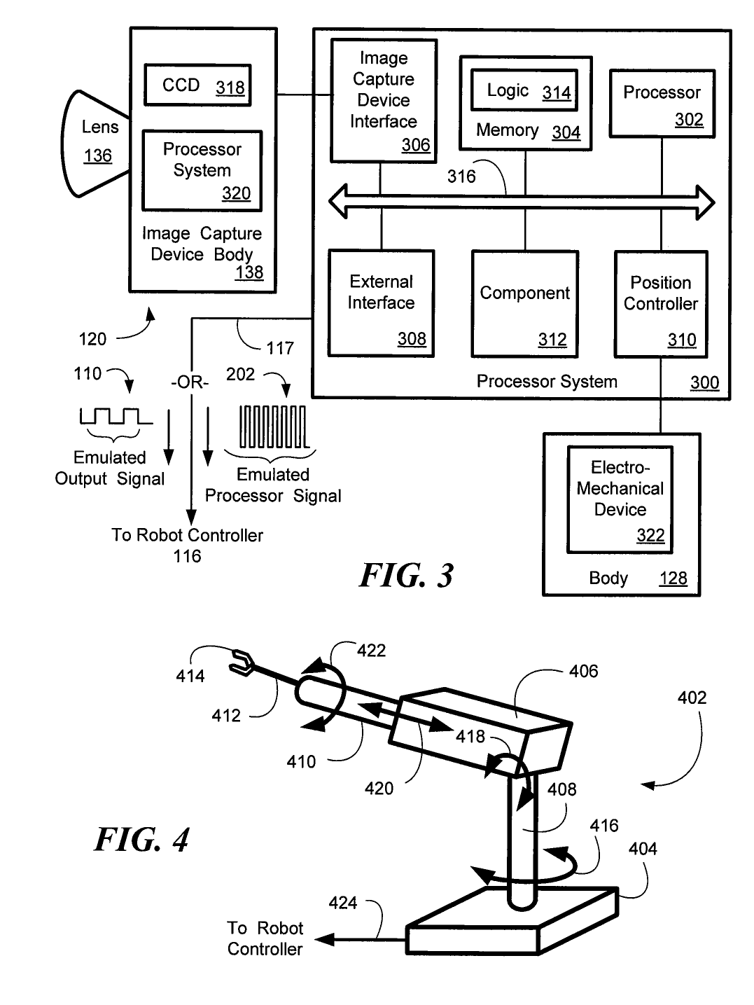

FIG. 2 is a perspective view of another vision tracking system embodiment 100 tracking a workpiece 104 on a conveyor system 106 employing machine-vision techniques, and generating an emulated processor signal 202. the output of the vision tracking system embodiment 100 is a processor-suitable signal that may be communicated directly to the robot controller 116. In some situations, the vision tracking system embodiment 100 may emulate the output of the intermediary transducer 114. In other situations, the vision tracking system embodiment 100 may determine and generate an output signal that replaces the output of the intermediary transducer 114. For convenience and clarity, with respect to the embodiment illustrated in FIG. 2, the output of the vision tracking system embodiment 100 is referred to herein as the “emulated processor signal” 202.

As noted above, various electromechanical movement detection devices, such as a shaft encoder, generate output signals corresponding to movement of belt 112. For example, a shaft encoder may generate one or more output square wave voltage signals or the like which are communicated to transducer 114. Transducer 114 then outputs a corresponding processor signal to the robot controller 116. The generated processor signal has a signal format suitable for the processing system of the robotic controller 116. Thus, this embodiment advantageously eliminates the intermediary transducer 114 that performs the preprocessing that transforms the analog encoder formatted information into digital information for the robot controller 116.

Embodiments of the vision tracking system 100 may be configured to track movement of a feature of the workpiece 104 such as feature 108 using machine-vision techniques, and computationally determine position, velocity and/or acceleration of the workpiece 104. Alternatively, the vision tracking system 100 may be configured to track movement of the belt 112 or another component whose movement is relatable to the speed of movement of the belt 112 and/or workpiece 104. Here, since characteristics of transducer 114 (FIG. 1) are known, the vision tracking system 100 computationally determines the characteristics of the emulated processor signal 202 so that it matches the above-described processor signal generated by a transducer 114 (FIG. 1). For example, the emulated processor signal 202 may take the form of one or more digital signals encoding the deduced position, velocity and/or acceleration parameters. Accordingly, the transducers 114 are no longer required to generate and communicate the processor signal to the robot controller 116.

FIG. 3 is a block diagram of a processor system 300 employed by embodiments of the vision tracking system 100. One embodiment of processor system 300 comprises at least a processor 302, a memory 304, an image capture device interface 306, an external interface 308, an optional position controller 310 and other optional components 312. Logic 314 resides in or is implemented in the memory 304.

The above-described components are communicatively coupled together via communication bus 316. In alternative embodiments, the above-described components may be connectively coupled to each other in a different manner than illustrated in FIG. 3. For example, one or more of the above-described components may be directly coupled to processor 302 or may be coupled to processor 302 via intermediary components (not shown). In other embodiments, selected ones of the above-described components may be omitted and/or may reside remote from the processor system 300.

Processor system 300 is configured to perform machine-vision processing on visual information provided by the image capture device 120. Such machine-vision processing may, for example, include: calibration, training features, and/or feature recognition during runtime, as taught in commonly assigned U.S. patent application Ser. No. 10/153,680 filed May 24, 2002 now U.S. Pat. No. 6,816,755; U.S. patent application Ser. No. 10/634,874 filed Aug. 6, 2003; and U.S. patent application Ser. No. 11/183,228 filed Jul. 14, 2005, each of which is incorporated by reference herein in their entireties.

A charge coupled device (CCD) 318 or the like resides in the image capture device body 138. Images are focused onto the CCD 318 by lens 136. An image capture device processor system 320 recovers information corresponding to the captured image from the CCD 318. The information is then communicated to the image capture device interface 306. The image capture device interface 306 formats the received information into a format suitable for communication to processor 302. The information corresponding to the image information, or image data, may be buffered into memory 304 or into another suitable memory media.

In at least some embodiments, logic 314 executed by processor 302 contains algorithms that interpret the received captured image information such that position, velocity and/or acceleration of the workpiece 104 and/or the robotic device 114 (or portions thereof) may be computationally determined. For example, logic 314 may include one or more object recognition or feature identification algorithms to identify feature 108 or another object of interest. As another example, logic 314 may include one or more edge detection algorithms to detect the robotic device 114 (or portions thereof).

Logic 314 further includes one or more algorithms to compare the detected features (such as, but not limited to, feature 108, objects of interest and/or edges) between successive frames of captured image information. Determined differences, based upon the time between compared frames of captured image information, may be used to determine velocity and/or acceleration of the detected feature. Based upon the known workspace geometry, position of the feature in the workspace geometry can then be determined. Based upon the determined position, velocity and/or acceleration of the feature, and based upon other knowledge about the workpiece 104 and/or the robotic device 402, the position, velocity and/or acceleration of the workpiece 104 and/or the robotic device 402 can be determined. There are many various possible object recognition or feature identification algorithms, which are too numerous to conveniently describe herein. All such algorithms are intended to be within the scope of this disclosure.

As noted above, some embodiments of logic 314 contain conversion information such that the determined position, velocity and/or acceleration information can be converted into information corresponding to the above described output signal of a shaft encoder or the signal of another electro-mechanical movement detection device. Accordingly, the logic 314 may contain a conversion algorithm which is configured to determine the above-described emulated output signal 110 (FIG. 1). For example, with respect to a shaft encoder, one or more emulated output square wave signals 110 (wherein the frequency of the square waves correspond to velocity) can be generated by the vision tracking system 100, thereby replacing the signal from a shaft encoder that would otherwise be communicated to the transducer 114.

Accordingly, external interface 308 receives the information corresponding to the determined emulated output signal 110. External interface device 308 generates the emulated output signal 110 that emulates the output of a shaft encoder (e.g., the square wave voltage signals), and communicates the emulated output signal 110 to a transducer 114 (FIG. 1). Other embodiments are configured to output signals that emulate the output of any electromechanical movement detection device used to sense velocity and/or acceleration.

The output of the external interface 308 may be directly coupleable to a transducer 114 in the embodiments of FIG. 1. Such embodiments may be used to replace electromechanical movement detection devices, such as shaft encoders or the like, of existing conveyor systems 106. Furthermore, changes in the configuration of the conveyor system 106 may be made without the need of re-calibrating or re-initializing the system.

In another embodiment of the vision tracking system 100, logic 314 may contain a conversion algorithm which is configured to determine the above-described emulated processor signal 202 (FIG. 2). For example, an emulated processor signal 202 can be generated by the vision tracking system 100, thereby replacing the signal from the transducer 114 that is communicated to the robot controller 116. Accordingly, external interface 308 receives the information corresponding to the determined emulated processor signal 202. Then, external interface device 308 generates the emulated processor signal 202, and communicates the emulated processor signal 202 to the robot controller 116. Other embodiments are configured to output signals that emulate the output of transducers 114 which generate processor signals based upon information received from any electromechanical movement detection device used to sense velocity and/or acceleration.

The output of the external interface 308 may be directly coupleable to a robot controller 116. Such an embodiment may be used to replace electromechanical movement detection devices, such as shaft encoders or the like, and their associated transducers 114 (FIG. 1), used in existing conveyor systems 106. Furthermore, changes in the configuration of the conveyor system 106 may be made without the need of re-calibrating or re-initializing the system.

FIG. 4 is a perspective view of a simplified robotic device 402. Here, the robotic device 402 is mounted on a base 404. The body 406 is mounted on a pedestal 408. Manipulators 410, 412 extend outward from the body 406. At the distal end of the manipulator 412 is the end effector 414.

It is appreciated that the simplified robotic device 402 may orient its end effector 414 in a variety of positions and that robotic devices may come in a wide variety of forms. Accordingly, the simplified robotic device 402 is intended to provide a basis for demonstrating the various principles of operation for the various embodiments of the vision tracking system 100 (FIGS. 1 and 2). To illustrate some of the possible variations of various robotic devices, some characteristics of interest of the robotic device 402 are described below.

Base 404 may be stationary such that the robotic device 402 is fixed in position, particularly with respect to the workspace geometry. For convenience, base 404 is presumed to be sitting on a floor. However, in other robotic devices, the base could be fixed to a ceiling, to a wall, to portion of the conveyor system 106 (FIG. 2) or any other suitable structure. In other robotic devices, the base could include wheels, rollers or the like with motor drive systems such that the position of the robotic device 402 is controllable. Or, the robotic device 402 could be mounted on a track or other transport system.

The robot body 406 is illustrated for convenience as residing on a pedestal 108. Rotational devices (not shown) in the pedestal 408, base 404 and/or body 406 may be configured to provide rotation of the body 406 about the pedestal 408, as illustrated by the arrow 416. Furthermore, the mounting device (not shown) coupling the body 406 to the pedestal 408 may be configured to provide rotation of the body 406 about the top of the pedestal 408, as illustrated by the arrow 418.

Manipulators 410, 412 are illustrated as extending outwardly from the body 406. In this simplified example, the manipulators 410, 412 are intended to be illustrated as telescoping devices such that the extension distance of the end effector 414 out from the robot body 406 is variable, as indicated by the arrow 420. Furthermore, a rotational device (not shown) could be used to provide rotation of the end effector 414, as indicated by the arrow 422. In other types of robotic devices, the manipulators may be more or less complex. For example, manipulators 410, 412 may be jointed, thereby providing additional angular degrees of freedom for orienting the end effector 414 in a desired position. Other robotic devices may have more than, or less than, the two manipulators 410, 412 illustrated in FIG. 4.

Robotic devices 402 are typically controlled by a robot controller 116 (FIGS. 1 and 2) such that the intended work on the workpiece 104, or a portion thereof, may be performed by the end effector 414. Instructions are communicated from the robot controller 116 to the robotic device 402 such that the various motors and electromechanical devices are controlled to position the end effector 414 in an intended position so that the work can be performed.

Resolvers (not shown) residing in the robotic device 402 provide positional information to the robot controller 116. Examples of resolvers include, but are not limited to, joint resolvers which provide angle position information and linear resolvers which provide linear position information.

The provided positional information is used to determine the position of the various components of the robotic device 402, such as the end effector 414, manipulators 410, 412, body 406 and/or other components. The resolvers are typical electromechanical devices that output signals that are communicated to the robot controller 116 (FIGS. 1 and 2), via connection 424 or another suitable communication path or system. In some robotic devices 402, intermediary transducers 114 are employed to convert signals received from the resolvers into signals suitable for the processing system of the robot controller 116.

Embodiments of the vision tracking system 100 may be configured to track features of a robotic device 402. These features, similar to the features 108 of the workpiece 104 or features associated with the conveyor system 106 described herein, may be associated with or be on the end effector 414, manipulators 410, 412, body 406 and/or other components of the robotic device 402.

Embodiments of the vision tracking system 100 may, based upon analysis of captured image information using any of the systems or methods described herein that determine information pertaining to a feature, determine information that replaces positional information provided by a resolver. Furthermore, the information may pertain to velocity and/or acceleration of the feature.

With respect to robotic devices 402 that employ intermediary transducers 114, the vision tracking system 100 determines an emulated output signal 110 (FIG. 1) that corresponds to a signal output by a resolver (that would otherwise be communicated to an intermediary transducers 114). Alternatively, the vision tracking system 100 may determine a processor signal 202 (FIG. 2) and communicates the processor signal 202 directly to the robot controller 116. With respect to robotic devices 402 that communicate information directly to the robot controller 116, the vision tracking system 100 may determine a processor signal 202 that corresponds to a signal output by a resolver (that would otherwise be communicated to the robot controller 116). Accordingly, it is appreciated that the various embodiments of the vision tracking system 100 described herein may be configured to replace signals provided by resolvers and/or their associated intermediary transducers.

For convenience, a connection 424 is illustrated as providing connectivity to the remotely located robot controller 116 (FIGS. 1 and 2), wherein a processing system resides. Here, the robot controller 116 is remote from the robotic device 402. Connection 424 is illustrated as a hardwire connection. In other systems, the robot controller 116 and the robotic device 402 may be communicatively coupled using another media, such as, but not limited to, a wireless media. Examples of wireless media include radio frequency (RF), infrared, visible light, ultrasonic or microwave. Other wireless media could be employed. In other types of robotic devices, the processing systems and/or robot controller 116 may reside internal to, or may be attached to, the robotic device 402.

The simplified robotic device 402 of FIG. 4 may be configured to provide at least six degrees of freedom for orienting the end effector 414 into a desired position to perform work on the workpiece or a portion thereof. Other robotic devices may be configured to provide other ranges of motion of the end effector 414. For example, a moveable base 408, or addition of joints to connect manipulators, will increase the possible ranges of motion to the end effector 414.

For convenience, the end effector 414 is illustrated as a simplified grasping device. As noted above, the robotic device 402 may be configured to position any type of working device or tool in proximity to the workpiece 104. Examples of other types of end effectors include, but are not limited to, socket devices, welding devices, spray paint devices or crimping devices. It is appreciated that the variety of, and variations to, robotic devices, end effectors and their operations on a workpiece are limitless, and that all such variations are intended to be included within the scope of this disclosure.

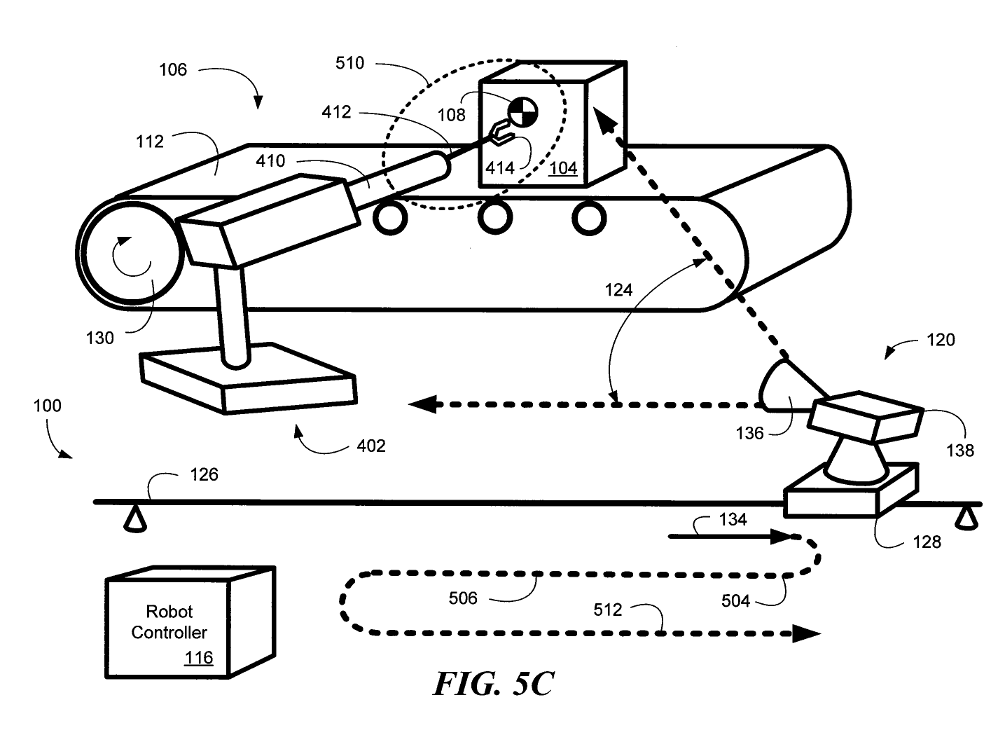

FIGS. 5A-C are perspective views of an exemplary vision tracking system 100 embodiment tracking a workpiece 104 on a conveyor system 106 when a robotic device 402 causes an occlusion. In FIG. 5A, the workpiece 104 has advanced along the conveyor system 106 towards the robotic device 402. Additionally, the robotic device 402 could also be advancing towards the workpiece 104.

The end effector 414 and the manipulators 410, 412 are now within the viewing angle 124 of the image capture device 120, as denoted by the circled region 402. Here, the end effector 414 and the manipulators 220, 112 may be partially blocking image capture device's 208 view of the workpiece 104. At some point, after additional movement of the workpiece 104 and/or the robotic device 402, view of the feature 108 will eventually be blocked. That is, the image capture device 120 will no longer be able to view the feature 108 so that the robot controller 116 may accurately and reliably determine position of the workpiece 104 and the end effector 414 relative to each other. This view blocking may be referred to herein as an occlusion.

The portion of the field of view 124 that is blocked, denoted by the circled region 402, is hereinafter referred to as an occlusion region 502. As noted above, it is undesirable to have operating conditions wherein the image capture device 120 will no longer be able to view the feature 108 so that the robot controller 116 may not be able to accurately and reliably determine position of the workpiece 104 and the end effector 414 relative to each other. Such operating conditions are hereinafter referred to as an occlusion event. When the ability to accurately and reliably track the workpiece 104 and/or the end effector 414 is degraded or lost during occlusion events, the robotic process may misoperate or even fail. Accordingly, it is desirable to avoid occlusions of visually detected features 108 of the workpiece 104.

As noted above, before the occurrence of the occlusion event, as the workpiece 104 is advanced along the transport path defined by the nature of the conveyor system 106 (e.g., linear path indicated by arrow 132), the image capture device 120 is concurrently moved along the track 126 at approximately the same velocity as the workpiece 104, as denoted by the arrow 134. That is, the relative position of the image capture device 120 with respect to the workpiece 104 is approximately constant.

Upon detection of the occlusion (determination of an occlusion in the occlusion region 502), the vision tracking system 100 adjusts movement of the image capture device 120 to eliminate or minimize the occlusion. For example, in response to the vision tracking system 100 detecting an occlusion event, the image capture device 120 may be moved backward, stopped or decelerated to avoid or mitigate the effect of the occlusion. For example, FIG. 5A shows that the image capture device 120 moves in the opposite direction of movement of the workpiece 104, as denoted by the dashed line 504 corresponding to a path of travel.

FIG. 5B illustrates an exemplary movement of an image capture device 120 capable of at least the above-described panning operation. Upon detection of the occlusion event, the image capture device 120 is moved backwards (as denoted by the dashed arrow 506 corresponding to a path of travel) so that the image capture device 120 is even with or behind the robotic device 402 such that the occlusion region 502 is not blocking view of the feature 108. As part of the process of re-orienting the image capture device 120 by moving as illustrated, the body 138 is rotated or panned (denoted by the arrow 508) such that the field of view 124 changes as illustrated.

FIG. 5C illustrates an exemplary movement of an image capture device 120 at the end of the occlusion event, wherein the region 510 is no longer an occlusion region because end effector 414 and the manipulators 410, 412 are not blocking view of the feature 108. Here, the image capture device 120 has moved forward (denoted by the arrow 512) and is now tracking with the movement of the workpiece 104.

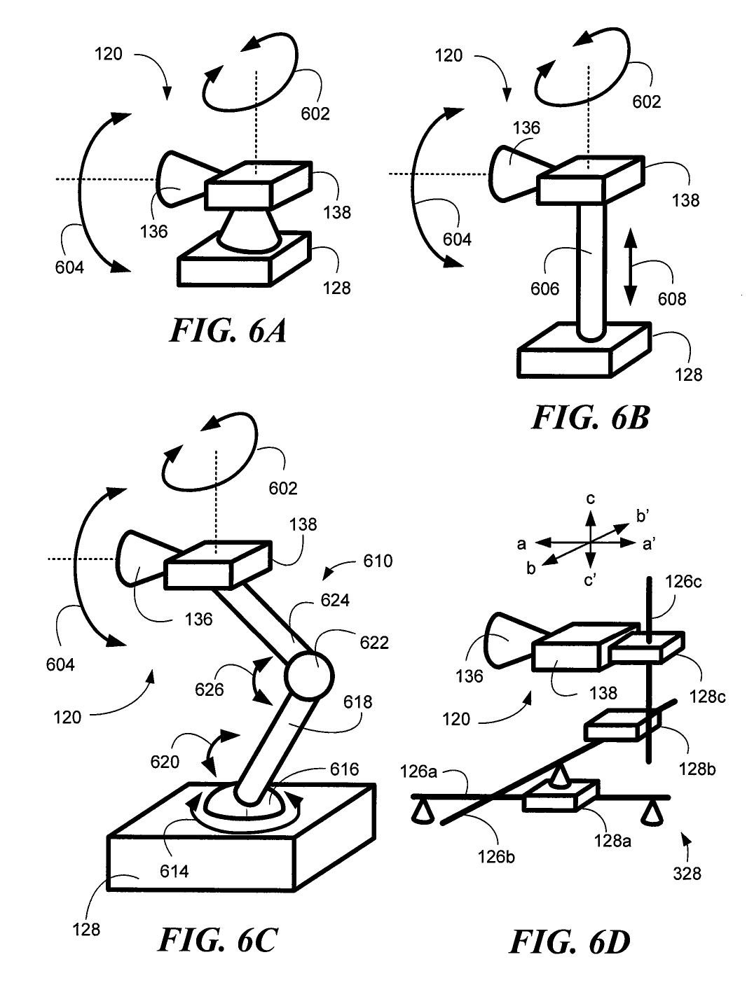

It is appreciated that the image capture device 120 may be moved in any suitable manner be embodiments of the vision tracking system 100 to avoid or mitigate the effect of occlusion events. As other non-limiting examples, the image capture device 120 could accelerate in the original direction of travel, thereby reducing the period of the occlusion event. In other embodiments, such as those illustrated in FIGS. 6A-D, the image capture device 120 could be re-oriented by employing pan/tilt operations, and/or by moving the image capture device 120 in an upward/downward or forward/backward direction in addition to above-described movements made in the sideways direction along track 126.

Detection of occlusion events are determined upon analysis of captured image data. Various captured image data analysis algorithms may be configured to detect the presence or absence of one or more visible features 108. For example, if a plurality of features 108 are used, then information corresponding to a blocked view of one of the features 108 (or more than one features 108) could be used to determine the position and/or characteristics of the occlusion, and/or determine the velocity of the occlusion. Accordingly, the image capture device 120 would be selectively moved by embodiments of the vision tracking system 100 as described herein.

In some embodiments, known occlusions may be communicated to the vision tracking system 100. Such occlusions may be predicted based upon information available to or known by the robot controller 116, or the occlusions may be learned from prior robotic operations.

Other captured image data analysis algorithms may be used to detect occlusion events. For example, edge-detection algorithms may be used by some embodiments to detect (computationally determine) a leading edge or another feature of the robotic device 402. Or, in other embodiments, one or more features may be located on the robotic device 402 such those features may be used to detect position of the robotic device 402. In other embodiments, motion of the robotic device 402 or its components may be learned, predictable or known.

In yet other embodiments, once the occurrence of an occlusion event and characteristics associated with the occlusion event is determined, the nature of progression of the occlusion event may be predicted. For example, returning to FIG. 5A, the vision tracking system may identify leading edges of the end effector 414, the manipulator 410 and/or manipulator 412 as the detected leading edge begins to enter into the field of view 124. Since the movement of the robotic device 402 is known, and/or since movement of the workpiece 104 is known, the vision tracking system 100 can use predictive algorithms to predict, over time, future location of the end effector 414, the manipulator 410 and/or manipulator 412 with respect to cue(s) 216. Accordingly, based upon the predicted nature of the occlusion event, the vision tracking system 100 may move the image capture device 120 in an anticipatory manner to avoid or mitigate the effect of the detected occlusion event. During an occlusion event, as the image capture device(s) 120 are being re-positioned, some embodiments of the visual tracking system 100 may use a prediction mechanism or the like to continue to send tracking data to the robot controller 116 while the image capture device(s) 120 are being re-positioned and features are being re-acquired.

In some embodiments, the robot controller 116 communicates tracking instruction signals, via connection 117 (FIGS. 1 and 2), to the operable components of the positioning system 122 based upon known and predefined movement of the workpiece 104 and/or the robotic device 402 (for example, see FIGS. 5A-C). Thus, the positioning system 122 tracks at least movement of the workpiece 104.

In other embodiments, described in greater detail hereinbelow, velocity and/or acceleration information pertaining to movement of the workpiece 104 is provided to the robot controller 116 based upon images captured by the image capture device 120. Accordingly, the image capture device 120 communicates image data to the processor system 300 (FIG. 3). The processor system 300 executes one or more image data analysis algorithms to determine, directly or indirectly, the movement of at least the workpiece 104. For example, changes in the position of the feature 108 between successive video or still frames is evaluated such that position, velocity and/or acceleration is determinable. In other embodiments, the visually sensed feature may be remote from the workpiece 104. Once the position, velocity and/or acceleration information has been determined, the processor system 300 communicates tracking instructions (signals) to the operable components of the positioning system 122.

Logic 314 (FIG. 3) includes one or more algorithms that then identify the above-described occurrence of occlusion events. For example, if view of one or more features 108 (FIG. 1) becomes blocked (the feature 108 is no longer visible or detectable), the algorithm may determine that an occlusion event has occurred or is in progress. As another example, if one or more portions of the manipulators 410, 412 (FIG. 4) are detected as they come into the field of view 124, the algorithm may determine that an occlusion event has occurred or is in progress. There are many various possible occlusion occurrence determination algorithms, which are too numerous to conveniently describe herein. All such algorithms are intended to be within the scope of this disclosure.

Logic 314 may include one or more algorithms to predict the occurrence of an occlusion. For example, if one or more portions of the manipulators 410, 412 are detected as they come into the field of view 124, the algorithm may determine that an occlusion event will occur in the future, based upon knowledge of where the workpiece 104 currently is, and will be in the future, in the workspace geometry. As another example, the relative positions of the workpiece 104 and robotic device 114 or portions thereof may be learned, known or predefined over the period of time that the workpiece 104 is in the workspace geometry. There are many various possible predictive algorithms, which are too numerous to conveniently describe herein. All such algorithms are intended to be within the scope of this disclosure.

Logic 314 further includes one or more algorithms that determine a desired position of the image capture device 120 such that the occlusion may be avoided or interference by the occlusion mitigated. As described above, the position of the image capture device 120 relative to the workpiece 104 (FIG. 1) may be adjusted to keep features 108 within the field of view 124 so that the robot controller 116 may accurately and reliably determine at least the position of the workpiece 104 and end effector 414 (FIG. 4) relative to each other.

As noted above, a significant deficiency in prior art systems employing vision systems is that the object of interest, such as the workpiece or a feature thereon, may move out of focus as the workpiece is advanced along the assembly line. Furthermore, if the vision system is mounted on the robotic device, the workpiece and/or feature may also move out of focus as the robot device moves to position its end effector in proximity to the workpiece. Accordingly, such prior art vision systems must employ complex focusing or auto-focusing systems to keep the object of interest in focus.

In the various embodiments wherein the image capture device 120 is concurrently moved along the track 126 at approximately the same velocity (speed and direction) as the workpiece 104, the relative position of the image capture device 120 with respect to the workpiece 104 is approximately constant. Focus of the feature 108 in the field of view 124 is based upon the focal length 233 of the lens 136 of the image capture device. Because the image capture device 120 is concurrently moved along the track 126 at approximately the same velocity as the workpiece 104, the distance from the lens 136 remains relatively constant. Since the focal length 233 remains relatively constant, the feature 108 or other objects of interest remain in focus as the workpiece 104 is transported along the conveyor system 106. Thus, the complex focusing or auto-focusing systems used by prior art vision systems may not be necessary.

FIGS. 6A-C are perspective views of various image capture devices 120 used by vision tracking system 100 embodiments. These various embodiments permit greater flexibility in tracking the image capture device 102 with the workpiece 104, and greater flexibility in avoiding or mitigating the effect of occlusion events.

In FIG. 6A, the image capture device 120 includes internal components (not shown) that provide for various rotational characteristics. One embodiment provides for a rotation around a vertical axis (denoted by the arrow 602), referred to as a “pan” direction, such that the image capture device 120 may adjust its field of view by panning the body 138 as illustrated. The image capture device 120 if further configured to provide a rotation about a horizontal axis (denoted by the arrow 604), referred to as a “tilt” direction, such that the image capture device 120 may adjust its field of view by tilting the body 138 as illustrated. Alternative embodiments may be configured with only a tilting or a panning capability.

In FIG. 6B, the image capture device 120 is coupled to a member 606 that provides for an upward/downward movement (denoted by the arrow 608) of the image capture device 120 along a vertical axis. In one embodiment, the member 606 is a telescoping device or the like. Other operable members and or systems may be used to provide the upward/downward movement of the image capture device 120 along the vertical axis by alternative embodiments. The image capture device 120 may include internal components (not shown) that provide for optional pan and/or tilt rotational characteristics.

In FIG. 6C, the image capture device 120 is coupled to a system 310 that provides for an upward/downward movement and a rotational movement (around a vertical axis) of the image capture device 120. For convenience, the illustrated embodiment of system 610 is coupled to an image capture device 120 that may include internal components (not shown) that provide for optional pan and/or tilt rotational characteristics.

Rotational movement around a vertical axis (denoted by the double headed arrow 614) is provided by a joining member 616 that rotationally joins base 128 with member 618. In some embodiments, a pivoting movement (denoted by the double headed arrow 620) of member 618 about joining member 616 may be provided.

In the illustrated embodiment of system 610, another joining member 622 couples the member 618 with another member 624 to provide additional angular movement (denoted by the double headed arrow 626) between the members 616 and 624. It is appreciated that alternatively embodiments may omit the member 624 and joining member 622, or may include other members and/or joining members to provide greater rotational flexibility.

In the illustrated embodiments of FIGS. 6A-C, the image capture device 120 is coupled to the above-described image capture device base 128, As noted above, the base 128 is coupled to the track 126 (FIG. 2) such that the image capture device 120 may be concurrently moved along the track 126 at approximately the same velocity as the workpiece 104.

In FIG. 6D, the image capture device 120 is coupled to a system 628 that provides for an upward/downward movement (along the illustrated “c” axis), a forward/backward movement (along the illustrated “b” axis) and/or a sideways movement (along the illustrated “a” axis) of the image capture device 120. The illustrated embodiment of system 328 may be coupled to an image capture device 120 that may include internal components (not shown) that provide for optional pan and/or tilt rotational characteristics.

As noted above and illustrated in FIG. 1, base 128a generally corresponds to base 128. Accordingly, base 128a is coupled to the track 126a (see track 126 in FIG. 2) such that the image capture device 120 may be concurrently moved along the track 126a (the sideways movement along the illustrated “a” axis) at approximately the same velocity as the workpiece 104.

A second track 126b is coupled to the base 128a that is oriented approximately perpendicularly and horizontally to track 126a such that the image capture device 120 may be concurrently moved along the track 126b (the forward/backward movement along the illustrated “b” axis), as it is moved by base 128b. A third track 126c is coupled to the base 128b that is oriented approximately perpendicularly and vertically to track 126b such that the image capture device 120 may be concurrently moved along the track 126c (the upward/downward movement along the illustrated “c” axis), as it is moved by base 128c. The image capture device body 138 is coupled to the base 128c.

In alternative embodiments, the above-described tracks 214a, 214b and 214c may be coupled together by their respective bases 212a, 212b and 212c in a different order and/or manner than illustrated in FIG. 6D. Alternatively, one of tracks 214b or 214c may be coupled to track 126a by their respective bases 212b or 212c (thereby omitting the other track and base) such that movement is provided in a sideways and forward/backward movement, or a sideways and upward/downward movement, respectively.

In alternative embodiments, the-above described features of the members or joining members illustrated in FIGS. 6A-D may be interchanged with each other to provide further movement capability to the image capture device 120. For example, track 126c and base 128c (FIG. 6C) of system 628 could be replaced by member 606 (FIG. 6B) to provide upward/downward movement of the image capture device 120. Similarly, with respect to FIG. 6B, member 606 could be replaced by the track 126c and base 128c (FIG. 6C) to provide upward/downward movement of the image capture device 120. Such variations in embodiments are too numerous to conveniently describe herein, and such variations are intended to be included within the scope of this disclosure.

Some embodiments of the logic 314 (FIG. 3) contain algorithms to determine instruction signals that are communicated to an electromechanical device 322 residing in the image capture device body 212 (FIGS. 2-6). As noted above, body 212 comprises means that move the image capture device 120 relative to the movement of the workpiece 104. In the exemplary embodiment, the moving means may be an electro-mechanical device 322 that propels the image capture device 120 along track 126. Accordingly, in one embodiment, the electro-mechanical device 322 may be an electric motor.

The generated instruction signals to control the electromechanical device 322 are communicated to the position controller 310 in some embodiments. Position controller 310 is configured to generate suitable electrical signals that control the electromechanical device 322. For example, if the electromechanical device 322 is an electric motor, the position controller 310 may generate and transmit suitable voltage and/or current signals that control the motor. One non-limiting example of a suitable voltage signal communicated to an electric motor is a rotor field voltage.

The various possible control algorithms, position controllers 310 and/or electromechanical devices 322 which are too numerous to conveniently describe herein. All such control algorithms, position controllers 310 and/or electro-mechanical devices 322 are intended to be within the scope of this disclosure.

As noted above, the processor system 300 may comprise one or more optional components 312. For example, if the above-described pan and/or tilt features are included in an embodiment of the vision tracking system 100, the component 312 may be a controller or interface device suitable for receiving instructions from a pan and/or tilt algorithm of the logic 314, and suitable for generating and communicating the control signals to the electro-mechanical devices which implement the pan and/or tilt functions. With respect to FIGS. 6A-D, a variety of electromechanical devices may reside in the various embodiments of the image capture device 120. Accordingly, such electromechanical devices will be controllable by the processor system 300 such that the field of view of the image capture device 120 may be adjusted so as to avoid or mitigate the effect of occlusion events.

For convenience, the embodiments which generate the above-described emulated output signal 110 (FIG. 1) and the above-described emulated processor signal 202 (FIG. 2) were described as separate embodiments. In other embodiments, multiple output signals may be generated. For example, one embodiment may generate a first signal that is an emulated output signal 110, and further generate a second signal that is an emulated processor signal 202 (FIG. 2). Other embodiments may be configured to generate a plurality of emulated output signals 110 and/or a plurality of emulated processor signals 202. There are many various possible embodiments which generate information corresponding to emulated output signals 110 and/or emulated processor signals 202. Such embodiments are too numerous to conveniently describe herein. All such algorithms are intended to be within the scope of this disclosure.

Any visually detectable feature on the conveyor system 106 and/or the workpiece 104 may be used to determine the velocity and/or acceleration information that is used to determine an emulated output signal 110 or an emulated processor signal 202. For example, edge detection algorithms may be used to detect movement of an edge associated with the workpiece 104. As another example, the rotational movement of tag or the like on the belt driver 130 (FIG. 2) can be visually detected. Or, frame differencing may be used to compare two successively captured images so that pixel geometries may be analyzed to determine movement of pixel characteristics, such as pixel intensity and/or color. Any suitable algorithm incorporated into logic 314 (FIG. 3) which is configured to analyze variable space-geometries may be used to determine velocity and/or acceleration information.

The above-described algorithms, and other associated algorithms, were illustrated for convenience as one body of logic (e.g., logic 314). Alternatively, some or all of the above-described algorithms may reside separately in memory 304, may reside in the image capture device 120, or may reside in other suitable media. Such algorithms may be executed by processor 302, or may be executed by other processing systems.

As noted above, the image capture device body 138 was configured to move along track 126 using a suitable moving means. In one exemplary embodiment, such moving means may be a motor or the like. In another embodiment, the moving means may be a chain system having chain guides. Or, another embodiment may be a motor that drives rollers/wheels residing in the base 128 wherein track 126 is used as a guide. In yet other embodiments, the base 128 could be a robotic device itself configured with wheels or the like such that position of the image capture device 120 is independently controllable. Such embodiments are too numerous to conveniently describe herein. All such algorithms are intended to be within the scope of this disclosure.

Some of the above-described embodiments included pan and/or tilt operations to adjust the field of view 124 of the image capture device 120 (FIGS. 6A-C, for example). Other embodiments may be configured with yaw and/or pitch control.

In some embodiments, the image capture device base 128 is configured to be stationary. Movement of the image capture device, if any, may be provided by other of the above-described features. Such an embodiment visually tracks one or more of the above-described features, and then generates one or more emulated output signals 110 and/or one or more emulated processor signals 202.

The above described embodiments of the image capture device 120 capture a series of time-related images. Information corresponding to the series of captured images is communicated to the processor system 300 (FIG. 3). Accordingly, the image capture device 120 may be video image capture device, or a still image capture device. If the image capture device 120 captures video information, it is appreciated that the video information is a series of still images separated by a sufficiently short time period such that when the series of images are displayed sequentially in a time-coordinated manner, the viewer is not able to perceive any discontinuities between successive image. That is, the viewer perceives a video image.

In embodiments that capture a series of still images, the time between capture of images may be defined such that the processor system 300 computationally determines position, velocity and/or acceleration of the workpiece 104, and/or an object that will be causing an occlusion event. That is, the series of still images will be captured with a sufficiently short enough time period between captured still images so that occlusion events can be detected and the appropriate corrective action taken by the vision tracking system 100.

As used herein, the workspace geometry is a region of physical space wherein the robotic device 402, at least a portion of the conveyor system 106, and the vision tracking system 100 reside. The robot controller 116 may reside in, or be external to, the workspace geometry. For purposes of computationally determining position, velocity and/or acceleration of the workpiece 104, and/or an object that will be causing an occlusion event, the workspace geometry may be defined by any suitable coordinate system, such as a Cartesian coordinate system, a polar coordinate system or another coordinate system. Any suitable scale of units may be used for distances, such as, but not limited to, metric units (i.e.: centimeters or meters, for example) or English units (i.e.: inches or feet, for example).

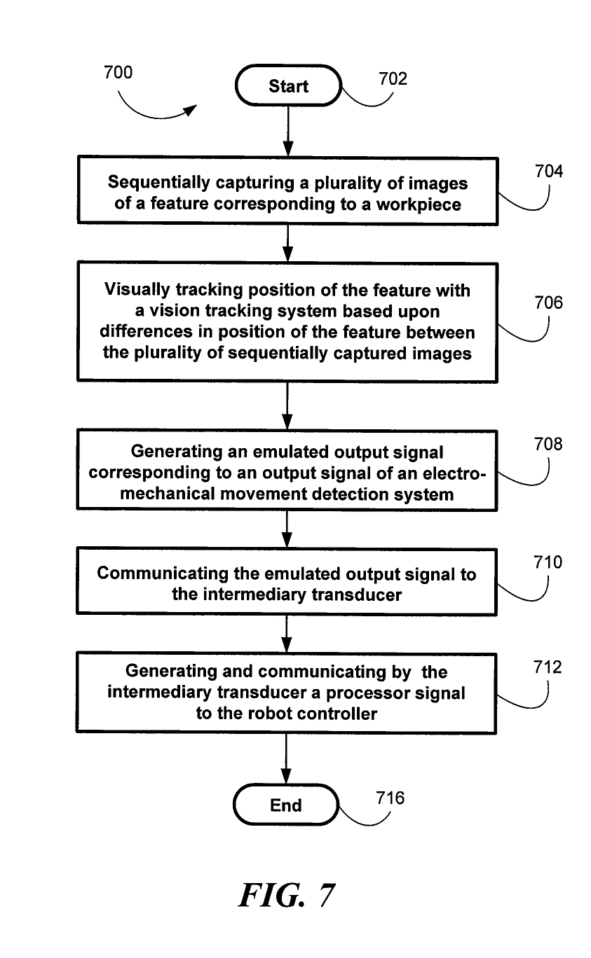

FIGS. 7-9 are flowcharts 700, 800 and 900 illustrating an embodiment of a process emulating or generating information signals. The flow charts 700, 800 and 900 show the architecture, functionality, and operation of an embodiment for implementing the logic 314 (FIG. 3). An alternative embodiment implements the logic of flow charts 700, 800 and 900 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIGS. 7-9, or may include additional functions. For example, two blocks shown in succession in FIGS. 7-9 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

FIG. 7 is a flowchart illustrating an embodiment of a process for emulating the output of an electromechanical movement detection system such as a shaft encoder. The process begins at block 702. At block 704, a plurality of images of a feature 108 (FIG. 1) corresponding to a workpiece 104 are captured by the vision tracking system 100. Alternatively, a feature of the conveyor system 106, a feature of a component of the conveyor system 106, or a feature attached to the workpiece 108 or conveyor system 106 may be captured.

The information corresponding to the captured images is communicated from the processor system 320 (FIG. 3) to the processor system 300. This information may be in an analog format or in a digital data format, depending upon the type of image capture device 120 employed, and may be generally referred to as image data. As noted above, whether image information is provided by a video camera or a still image camera, the image information is provided as a series of sequential, still images. Such still images may be referred to as an image frame.

At block 706, position of the feature 108 is visually tracked by the vision tracking system 100 based upon differences in position of the feature 108 between the plurality of sequentially captured images. Algorithms of the logic 314, in some embodiments, will identify the location of the tracked feature 108 in an image frame. In a subsequent image frame, the location of the tracked feature 108 is identified and compared to the location identified in the previous image frame. Differences in the location correspond to relative changes in position of the tracked feature 108 with respect to the image capture system 102.

In some embodiments, velocity of the workpiece may be optionally determined based upon the visual tracking of the feature 108. For example, if the image capture device 120 is moving such that the position of the image capture device 120 is approximately maintained relative to the movement of workpiece 104, location of the tracked feature 108 in compared image frames will be the approximately the same. Accordingly, the velocity of the workpiece 104, which corresponds to the velocity of the feature 108, is the same as the velocity of the image capture device 120. Differences in the location of the tracked feature 108 in compared image frames indicates a difference in velocities of the workpiece 104 and the image capture device 120, and accordingly, velocity of the workpiece may be determined.

At block 708, an emulated output signal 110 is generated corresponding to an output signal of an electromechanical movement detection system, such as a shaft encoder. In one embodiment, at least one square wave signal corresponding to at least one output square wave signal of the shaft encoder is generated, wherein frequency of the output square wave signal is proportional to a velocity detected by the shaft encoder.

At block 710, the emulated output signal 110 is communicated to the intermediary transducer 114. At block 712, the intermediary transducer 114 generates and communicates a processor signal 118 to the robot controller 116. The process ends at block 714.

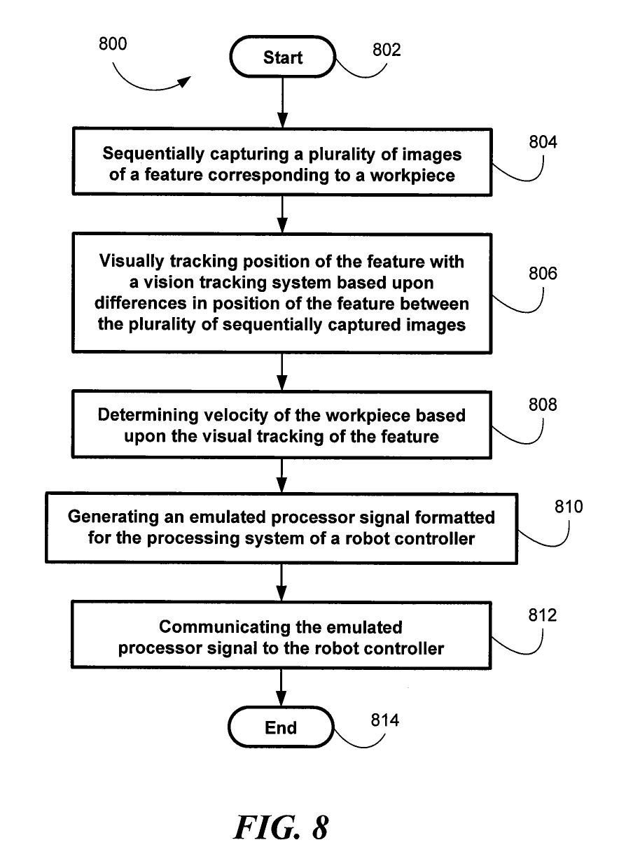

FIG. 8 is a flowchart illustrating an embodiment of a process for generating an output signal 202 (FIG. 2) that is communicated to a robot controller 116. The process begins at block 802. At block 804, a plurality of images of a feature 108 (FIG. 1) corresponding to a workpiece 104 are captured by the vision tracking system 100. Alternatively, a feature of the conveyor system 106, a feature of a component of the conveyor system 106, or a feature attached to the workpiece 108 or conveyor system 106 may be captured.

At block 806, position of the feature 108 is visually tracked by the vision tracking system 100 based upon differences in position of the feature 108 between the plurality of sequentially captured images. Algorithms of the logic 314, in some embodiments, will identify the location of the tracked feature 108 in an image frame. In a subsequent image frame, the location of the tracked feature 108 is identified and compared to the location identified in the previous image frame. Differences in the location correspond to relative changes in position of the tracked feature 108 with respect to the image capture system 102.

At block 808, velocity of the workpiece is determined based upon the visual tracking of the feature 108. For example, if the image capture device 120 is moving such that the position of the image capture device 120 is approximately maintained relative to the movement of workpiece 104, location of the tracked feature 108 in compared image frames will be the approximately the same. Accordingly, the velocity of the workpiece 104, which corresponds to the velocity of the feature 108, is the same as the velocity of the image capture device 120. Differences in the location of the tracked feature 108 in compared image frames indicates a difference in velocities of the workpiece 104 and the image capture device 120, and accordingly, velocity of the workpiece may be determined.

Optionally, after block 808, an output of a shaft encoder that corresponds to a velocity detected by the shaft encoder is determined. By determining the output of the shaft encoder, a conversion factor or the like can be applied to determine the output of an intermediary transducer 114. Alternatively, the output of the intermediary transducer 114 may be directly determined.

At block 810, an emulated processor signal 202 is determined. In embodiments performing the above-describe optional process of determining output of a shaft encoder, the emulated processor signal 202 may be based upon the determined output of the shaft encoder and based upon a conversion made by a transducer 114 that would convert the output of the shaft encoder into a signal formatted for the processing system of the robot controller 116.

At block 812, the emulated processor signal 202 is communicated to the robot controller 116. The process ends at block 814.

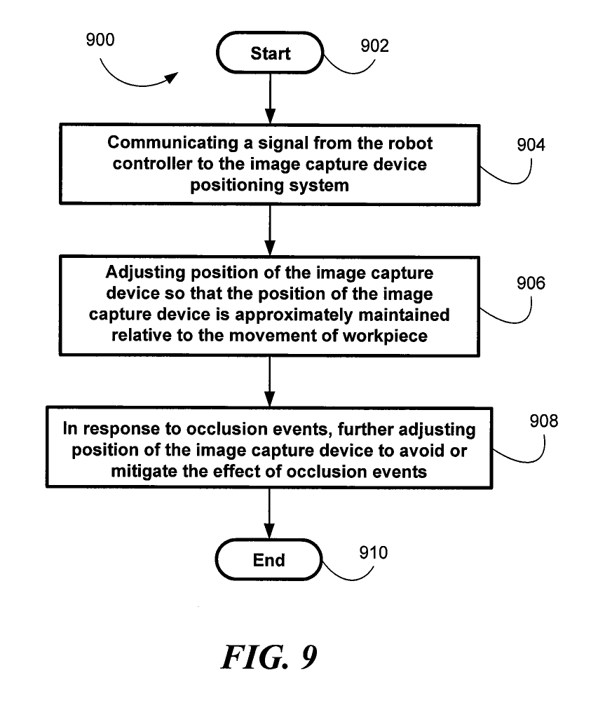

FIG. 9 is a flowchart illustrating an embodiment of a process for moving position of the image capture device 120 (FIG. 1) so that the position is approximately maintained relative to the movement of workpiece 104. The process starts at block 902, which corresponds to either of the ending blocks of FIG. 7 (block 716) or FIG. 8 (block 816). Accordingly, the robot controller 116 has received the processor signal 118 from transducer 114 based upon the emulated output signal 110 communicated from the vision tracking system 100 (FIG. 1), or the robot controller 116 has received an emulated processor signal 202 directly communicated from the vision tracking system 100 (FIG. 2).

At block 904, a signal is communicated from the robot controller 116 to the image capture device positioning system 122. At block 906, position of the image capture device 120 is adjusted so that the position of the image capture device 120 is approximately maintained relative to the movement of workpiece 104. At block 908, in response to occlusion events, position of the image capture device 120 is further adjusted to avoid or mitigate the effect of occlusion events. The process ends at block 910. In the above-described various embodiments, the processor system 300 (FIG. 3) may employ a processor 302 such as, but not limited to, a microprocessor, a digital signal processor (DSP), an application specific integrated circuit (ASIC) and/or a drive board or circuitry, along with any associated memory, such as random access memory (RAM), read only memory (ROM), electrically erasable read only memory (EEPROM), or other memory device storing instructions to control operation. The processor system 300 may be housed with other components of the image capture device 120, or may be housed separately.

In one aspect, a method operating a machine vision system to control at least one robot comprise: successively capturing images of an object; determining a linear velocity of the object from the captured images; and producing an encoder emulation output signal based on the determined linear velocity, the encoder emulation signal emulative of an output signal from an encoder. Successively capturing images of an object may include successively capturing images of the object while the object is in motion. For example, successively capturing images of an object may include successively capturing images of the object while the object is in motion along a conveyor system. Determining a linear velocity of the object from the captured images may include locating at least one feature of the object in at least two of the captured images, determining a change of position of the feature between the at least two of the captured images, and determining a time between the capture of the at least two captured images. Producing an encoder emulation output signal based on the determined linear velocity may include producing at least one encoder emulative waveform. Producing at least one encoder emulative waveform may include producing a single pulse train output waveform. Producing at least one encoder emulative waveform may include producing a quadrature output waveform comprising a first pulse train and a second pulse train. Producing at least one encoder emulative waveform may include producing at least one of a square-wave pulse train or a sine-wave wave form. Producing at least one encoder emulative waveform may include producing a pulse train emulative of an incremental output waveform from an incremental encoder. Producing at least one encoder emulative waveform may include producing an analog waveform. Producing an encoder emulation output signal based on the determined linear velocity may include producing a set of binary words emulative of an absolute output waveform of an absolute encoder. The method may further comprise: providing the encoder emulation signal to an intermediary transducer communicatively positioned between the machine vision system and a robot controller. The method may further comprise: providing the encoder emulation signal to an encoder interface card of a robot controller. The method may further comprise: automatically determining a position of the object with respect to the camera based at least in part on the captured images a change in position of the object between at least two of the images; and moving the camera relative to the object based at least in part on the determined position of the object with respect to the camera. Moving the camera relative to the object based at least in part on the determined position of the object with respect to the camera may, for example, include moving the camera to at least partially avoid an occlusion of a view of the object by the camera. Moving the camera relative to the object based at least in part on the determined position of the object with respect to the camera may, for example, include changing a movement of the object to at least partially avoid an occlusion of a view of the object by the camera. The method may further comprise: automatically determining at least one of a velocity or an acceleration of the object with respect to a reference frame; predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera; and determining at least one of a new position or a new orientation for the camera relative to the object that at least partially avoids the occlusion. The method may further comprise: determining whether at least one feature of the object in at least one of the images is occluded; and wherein moving the camera based at least in part on the determined position of the object with respect to the camera includes moving the camera to at least partially avoid the occlusion in a view of the object by the camera; and determining at least one of a new position or a new orientation for the camera relative to the object that at least partially avoids the occlusion. The method may further comprise: determining at least one other velocity of the object from the captured images; and producing at least one other encoder emulation output signal based on the determined other velocity, the at least one other encoder emulation signal emulative of an output signal from an encoder. Determining at least one other velocity of the object from the captured images may include determining at least one of an angular velocity or another linear velocity.

In another aspect, a machine vision system to control at least one robot, may comprise: a camera operable to successively capture images of an object in motion; means for determining a linear velocity of the object from the captured images; and means for producing an encoder emulation output signal based on the determined linear velocity, the encoder emulation signal emulative of an output signal from an encoder. The means for determining a linear velocity of the object from the captured images may include means for locating at least one feature of the object in at least two of the captured images, determining a change of position of the feature between the at least two of the captured images, and determining a time between the capture of the at least two captured images. The means for producing an encoder emulation output signal based on the determined linear velocity may produce at least one encoder emulative waveform selected from the group consisting of a single pulse train output waveform and a quadrature output waveform comprising a first pulse train and a second pulse train. The means for producing at least one encoder emulative waveform may produce a pulse train emulative of an incremental output waveform from an incremental encoder. The means for producing an encoder emulation output signal based on the determined linear velocity may produce a set of binary words emulative of an absolute output waveform of an absolute encoder. The machine vision system may be communicatively coupled to provide the encoder emulation signal to an intermediary transducer communicatively positioned between the machine vision system and a robot controller. The machine vision system may further comprise: at least one actuator physically coupled to move the camera relative to the object based at least in part on at least one of a position, a speed or a velocity of the object with respect to the camera to at least partially avoid an occlusion of a view of the object by the camera. The machine vision system may further comprise: at least one actuator physically coupled to adjust a movement of the object relative to the camera based at least in part on at least one of a position, a speed or a velocity of the object with respect to the camera to at least partially avoid an occlusion of a view of the object by the camera. The machine vision system may further comprise: means for automatically determining at least one of a velocity or an acceleration of the object with respect to a reference frame; means for predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera. The machine vision system may further comprise: means for determining at least one other velocity of the object from the captured images; and means for producing at least one other encoder emulation output signal based on the determined other velocity, the at least one other encoder emulation signal emulative of an output signal from an encoder. The means for determining at least one other velocity of the object from the captured images may include software means for determining at least one of an angular velocity or another linear velocity from the images.

In yet another aspect, a computer-readable medium may store instructions for causing a machine vision system to control at least one robot, by: determining at least one velocity of an object along or about at least a first axis from a plurality of successively captured images of the object; and producing at least one encoder emulation output signal based on the determined at least one velocity, the encoder emulation signal emulative of an output signal from an encoder. Producing at least one encoder emulation output signal based on the determined at least one velocity, the encoder emulation signal emulative of an output signal from an encoder may include producing at least one encoder emulative waveform selected from the group consisting of a single pulse train output waveform and a quadrature output waveform comprising a first pulse train and a second pulse train. Producing at least one encoder emulation output signal based on the determined at least one velocity, the encoder emulation signal emulative of an output signal from an encoder may include producing a set of binary words emulative of an absolute output waveform of an absolute encoder. The instructions may cause the machine-vision system to further control the at least one robot, by: predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera. The instructions may cause the machine-vision system to additionally control movement of the object, by: adjust a movement of the object relative to the camera based at least in part on at least one of a position, a speed or a velocity of the object with respect to the camera to at least partially avoid an occlusion of a view of the object by the camera. The instructions cause the machine-vision system to additionally control the camera, by: moving the camera relative to the object based at least in part on at least one of a position, a speed or a velocity of the object with respect to the camera to at least partially avoid an occlusion of a view of the object by the camera. Determining at least one velocity of an object along or about at least a first axis from a plurality of successively captured images of the object may include determining a velocity of the object along or about two different axes from the captured images; and wherein producing at least one other encoder emulation output signal based on the at least one determined velocity includes producing at least two distinct encoder emulation output signals, each of the encoder emulation output signals indicative of the determined velocity about or along a respective one of the axes.

In yet still another aspect, a method operating a machine vision system to control at least one robot, comprises: successively capturing images of an object; determining a first linear velocity of the object from the captured images; producing a digital output signal based on the determined first linear velocity, the digital output signal indicative of a position and at least one of a velocity and an acceleration; and providing the digital output signal to a robot controller without the use of an intermediary transducer. Successively capturing images of an object may include capturing successive images of the object while the object is in motion. For example, successively capturing images of an object may include capturing successive images of the object while the object is in motion along a conveyor system. Determining a first linear velocity of the object from the captured images may include locating at least one feature of the object in at least two of the captured images, determining a change of position of the feature between the at least two of the captured images, and determining a time between the capture of the at least two captured images. Providing the digital output signal to a robot controller without the use of an intermediary transducer may include providing the digital output signal to the robot controller without the use of an encoder interface card. The method may further comprise: automatically determining a position of the object with respect to the camera based at least in part on the captured images a change in position of the object between at least two of the images; and moving the camera relative to the object based at least in part on the determined position of the object with respect to the camera. Moving the camera relative to the object based at least in part on the determined position of the object with respect to the camera may include moving the camera to at least partially avoid an occlusion of a view of the object by the camera. Moving the camera relative to the object based at least in part on the determined position of the object with respect to the camera may include changing a speed of the object to at least partially avoid an occlusion of a view of the object by the camera. The method may further comprise: automatically determining at least one of a velocity or an acceleration of the object with respect to a reference frame; predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera; and determining at least one of a new position or a new orientation for the camera that at least partially avoids the occlusion. The method may further comprise: determining whether at least one feature object in at least one of the images is occluded; and wherein moving the camera based at least in part on the determined position of the object with respect to the camera includes moving the camera to at least partially avoid the occlusion in a view of the object by the camera; and determining at least one of a new position or a new orientation for the camera that at least partially avoids the occlusion. The method may further comprise: determining at least a second linear velocity of the object from the captured images, and wherein producing the digital output signal is further based on the determined second linear velocity. The method may further comprise: determining at least one angular velocity of the object from the captured images, and wherein producing the digital output signal is further based on the at least one determined angular velocity.

In even still another aspect, a machine vision system to control at least one robot, comprises: a camera operable to successively capture images of an object in motion; means for determining at least a velocity of the object along or about at least one axis from the captured images; means for producing a digital output signal based on the determined velocity, the digital output signal indicative of a position and at least one of a velocity and an acceleration, wherein the machine vision system is communicatively coupled to provide the digital output signal to a robot controller without the use of an intermediary transducer. The means for determining at least a velocity of the object along or about at least one axis from the captured images may include means for determining a first linear velocity along a first axis and means for determining a second linear velocity along a second axis. The means for determining at least a velocity of the object along or about at least one axis from the captured images may include means for determining a first angular velocity about a first axis and means for determining a second angular velocity about a second axis. The means for determining at least a velocity of the object along or about at least one axis from the captured images may include means for determining a first linear velocity about a first axis and means for determining a first angular velocity about the first axis. The machine vision system may further comprise: means for moving the camera relative to the object based at least in part on at least one of a position, a speed or an acceleration of the object with respect to the camera to at least partially avoid an occlusion of a view of the object by the camera. The machine vision system may further comprise: means for adjusting a movement of the object based at least in part on at least one of a position, a speed or an acceleration of the object with respect to the camera to at least partially avoid an occlusion of a view of the object by the camera. The machine vision system may further comprise: means for predicting an occlusion event based on at least one of a position, a velocity or an acceleration of the object.

In still yet another aspect, a computer-readable medium stores instructions to operate a machine vision system to control at least one robot, by: determining at least a first velocity of an object in motion from a plurality of successively captured images of the object; producing a digital output signal based on at least the determined first velocity, the digital output signal indicative of at least one of a velocity or an acceleration of the object; and providing the digital output signal to a robot controller without the use of an intermediary transducer. Determining at least a first velocity of an object may include a first linear velocity of the object along a first axis, and determining a second linear velocity along a second axis. Determining at least a first velocity of an object may include determining a first angular velocity about a first axis and determining a second angular velocity about a second axis. Determining at least a first velocity of an object may include determining a first linear velocity about a first axis and determining a first angular velocity about the first axis. The instructions may cause the machine vision system to control the at least one robot, further by: predicting an occlusion event based on at least one of a position, a velocity or an acceleration of the object.

In a further aspect, a method operating a machine vision system to control at least one robot, comprises: successively capturing images of an object with a camera that moves independently from at least an end effector portion of the robot; automatically determining at least a position of the object with respect to the camera based at least in part on the captured images a change in position of the object between at least two of the images; and moving at least one of the camera or the object based at least in part on the determined position of the object with respect to the camera. Moving at least one of the camera or the object based at least in part on the determined position of the object with respect to the camera may include moving the camera to track the object as the object moves. Moving at least one of the camera or the object based at least in part on the determined position of the object with respect to the camera may include moving the camera to track the object as the object moves along a conveyor. Moving at least one of the camera or object based at least in part on the determined position of the object with respect to the camera may include moving the camera to at least partially avoid an occlusion of a view of the object by the camera. Moving at least one of the camera or object based at least in part on the determined position of the object with respect to the camera may include adjusting a movement of the object to at least partially avoid an occlusion of a view of the object by the camera. The method may further comprise: automatically determining at least one of a velocity or an acceleration of the object with respect to a reference frame. The method may further comprise: predicting an occlusion event based on at least one of a position, a velocity or an acceleration of the object; and wherein moving at least one of the camera or the object based at least in part on the determined position of the object with respect to the camera includes moving the camera to at least partially avoid an occlusion of a view of the object by the camera. The method may further comprise: determining at least one of a new position or a new orientation for the camera that at least partially avoids the occlusion. The method may further comprise: predicting an occlusion event based on at least one of a position, a velocity or an acceleration of the object; and wherein moving at least one of the camera or the object based at least in part on the determined position of the object with respect to the camera includes adjusting a movement of the object to at least partially avoid an occlusion of a view of the object by the camera. The method may further comprise: determining at least one of at least one of a new position, a new speed, a new acceleration, or a new orientation for the object that at least partially avoids the occlusion. The method may further comprise: determining whether at least one feature of the object in at least one of the images is occluded; and wherein moving the camera based at least in part on the determined position of the object with respect to the camera includes moving the camera to at least partially avoid the occlusion in a view of the object by the camera. The method may further comprise: determining at least one of a new position or a new orientation for the camera that at least partially avoids the occlusion. Moving at least one of the camera or the object based at least in part on the determined position of the object with respect to the camera may include translating the camera. Moving at least one of the camera or the object based at least in part on the determined position of the object with respect to the camera may include change a speed at which the camera is translating. Moving at least one of the camera or the object based at least in part on the determined position of the object with respect to the camera may include pivoting the camera about at least one axis. Moving at least one of the camera or the object based at least in part on the determined position of the object with respect to the camera may include translating the object. Moving at least one of the camera or the object based at least in part on the determined position of the object with respect to the camera may include changing a speed at which the object is translating. Moving at least one of the camera or the object based at least in part on the determined position of the object with respect to the camera may include pivoting the object about at least one axis. Moving at least one of the camera or the object based at least in part on the determined position of the object with respect to the camera may include changing a speed at which the object is rotating.

In still a further aspect, a machine vision system to control at least one robot, comprises: a camera operable to successively capture images of an object in motion, the camera mounted; means for automatically determining at least a position of the object with respect to the camera based at least in part on the captured images a change in position of the object between at least two of the images; and at least one actuator coupled to move at least one of the camera or the object; and means for controlling the at least one actuator based at least in part on the determined position of the object with respect to the camera to at least partially avoid an occlusion of a view of the object by the camera. The machine vision system may further comprise: means for predicting an occlusion event based on at least one of a position, a velocity or an acceleration of the object. The machine vision system may further comprise: means for determining at least one of a new position or a new orientation for the camera that at least partially avoids the occlusion. In at least one embodiment, the actuator is physically coupled to move the camera. In such an embodiment, the machine vision system may further comprise: means for determining at least one of a new position or a new orientation for the object that at least partially avoids the occlusion. In another embodiment, the actuator is physically coupled to move the object. The machine vision system may further comprise: means for detecting an occlusion of at least one feature of the object in at least one of the images of the object. In such an embodiment, the machine vision system may further comprise: means for determining at least one of a new position or a new orientation for the camera that at least partially avoids the occlusion. In at least one embodiment, the actuator is physically coupled to move at least one of translate or rotate the camera. In such an embodiment, the machine vision system may further comprise: means for determining at least one of a new position or a new orientation for the object that at least partially avoids the occlusion. In such an embodiment, the actuator may be physically coupled to at least one of translate, rotate or adjust a speed of the object.

In yet still a further aspect, a computer-readable medium stores instructions that cause a machine vision system to control at least one robot, by: automatically determining at least a position of an object with respect to a camera that moves independently from at least an end effector portion of the robot, based at least in part on a plurality of successively captured images a change in position of the object between at least two of the images; and causing at least one actuator to move at least one of the camera or the object based at least in part on the determined position of the object with respect to the camera to at least partially avoid an occlusion of a view of the object by the camera. Causing at least one actuator to move at least one of the camera or the object based at least in part on the determined position of the object with respect to the camera to at least partially avoid an occlusion of a view of the object by the camera may include translating the camera along at least one axis. Causing at least one actuator to move at least one of the camera or the object based at least in part on the determined position of the object with respect to the camera to at least partially avoid an occlusion of a view of the object by the camera may include rotating the camera about at least one axis. Causing at least one actuator to move at least one of the camera or the object based at least in part on the determined position of the object with respect to the camera to at least partially avoid an occlusion of a view of the object by the camera may include adjusting a movement of the object. Adjusting a movement of the object may include adjusting at least one of a linear velocity or rotational velocity of the object. The instructions may cause the machine vision system to control the at least one robot, further by: predicting an occlusion event based on at least one of a position, a velocity or an acceleration of the object. The instructions may cause the machine vision system to control the at least one robot, further by: determining whether at least one feature of the object in at least one of the images is occluded. The instructions cause the machine vision system to control the at least one robot, further by: determining at least one of a new position or a new orientation for the camera that at least partially avoids the occlusion. The instructions cause the machine vision system to control the at least one robot, further by: determining at least one of a new position, a new orientation, or a new speed for the object which at least partially avoids the occlusion.

The various means discussed above may include one or more controllers, microcontrollers, processors (e.g., microprocessors, digital signal processors, application specific integrated circuits, field programmable gate arrays, etc.) executing instructions or logic, as well as the instructions or logic itself, whether such instructions or logic in the form of software, firmware, or implemented in hardware, without regard to the type of medium in which such instructions or logic are stored, and may further include one or more libraries of machine-vision processing routines without regard to the particular media in which such libraries reside, and without regard to the physical location of the instructions, logic or libraries.

The above description of illustrated embodiments is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other assembly systems, not necessarily the exemplary conveyor systems generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Pat. No. 6,816,755, issued Nov. 9, 2004; U.S. patent application Ser. No. 10/634,874, filed Aug. 6, 2003; U.S. provisional patent application Ser. No. 60/587,488, filed Jul. 14, 2004; U.S. patent application Ser. No. 11/183,228, filed Jul. 14, 2005; U.S. provisional patent application Ser. No. 60/719765, filed Sep. 23, 2005; U.S. provisional patent application Ser. No. 60/832,356, filed Jul. 20, 2006; U.S. provisional patent application Ser. No. 60/808,903, filed May 25, 2006; and U.S. provisional patent application Ser. No. 60/719,765, filed Sep. 23, 2005, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method operating a machine vision system to control at least one robot, the method comprising:
successively capturing images of an object;
determining a linear velocity of the object from the captured images; and
producing an encoder emulation output signal based on the determined linear velocity, the encoder emulation signal emulative of an output signal from an encoder.

2. The method of claim 1 wherein successively capturing images of an object includes successively capturing images of the object while the object is in motion.

3. The method of claim 1 wherein successively capturing images of an object includes successively capturing images of the object while the object is in motion along a conveyor system.

4. The method of claim 1 wherein determining a linear velocity of the object from the captured images includes locating at least one feature of the object in at least two of the captured images, determining a change of position of the feature between the at least two of the captured images, and determining a time between the capture of the at least two captured images.

5. The method of claim 1 wherein producing an encoder emulation output signal based on the determined linear velocity includes producing at least one encoder emulative waveform.

6. The method of claim 5 wherein producing at least one encoder emulative waveform includes producing a single pulse train output waveform.

7. The method of claim 5 wherein producing at least one encoder emulative waveform includes producing a quadrature output waveform comprising a first pulse train and a second pulse train.

8. The method of claim 5 wherein producing at least one encoder emulative waveform includes producing at least one of a square-wave pulse train or a sine-wave wave form.

9. The method of claim 1 wherein producing at least one encoder emulative waveform includes producing a pulse train emulative of an incremental output waveform from an incremental encoder.

10. The method of claim 1 wherein producing at least one encoder emulative waveform includes producing an analog waveform.

11. The method of claim 1 wherein producing an encoder emulation output signal based on the determined linear velocity includes producing a set of binary words emulative of an absolute output waveform of an absolute encoder.

12. The method of claim 1, further comprising:
providing the encoder emulation signal to an intermediary transducer communicatively positioned between the machine vision system and a robot controller.

13. The method of claim 1, further comprising:
providing the encoder emulation signal to an encoder interface card of a robot controller.

14. The method of claim 1, further comprising:
automatically determining a position of the object with respect to the camera based at least in part on the captured images a change in position of the object between at least two of the images; and
moving the camera relative to the object based at least in part on the determined position of the object with respect to the camera.

15. The method of claim 14 wherein moving the camera relative to the object based at least in part on the determined position of the object with respect to the camera includes moving the camera to at least partially avoid an occlusion of a view of the object by the camera.

16. The method of claim 14 wherein moving the camera relative to the object based at least in part on the determined position of the object with respect to the camera includes changing a movement of the object to at least partially avoid an occlusion of a view of the object by the camera.

17. The method of claim 16, further comprising:
automatically determining at least one of a velocity or an acceleration of the object with respect to a reference frame;
predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera; and
determining at least one of a new position or a new orientation for the camera relative to the object that at least partially avoids the occlusion.

18. The method of claim 14, further comprising:
determining whether at least one feature of the object in at least one of the images is occluded; and wherein moving the camera based at least in part on the determined position of the object with respect to the camera includes moving the camera to at least partially avoid the occlusion in a view of the object by the camera; and
determining at least one of a new position or a new orientation for the camera relative to the object that at least partially avoids the occlusion.

19. The method of claim 1, further comprising:
determining at least one other velocity of the object from the captured images; and
producing at least one other encoder emulation output signal based on the determined other velocity, the at least one other encoder emulation signal emulative of an output signal from an encoder.

20. The method of claim 1 wherein determining at least one other velocity of the object from the captured images includes determining at least one of an angular velocity or another linear velocity.

21. A machine vision system to control at least one robot, the machine vision system comprising:
a camera operable to successively capture images of an object in motion;
means for determining a linear velocity of the object from the captured images; and
means for producing an encoder emulation output signal based on the determined linear velocity, the encoder emulation signal emulative of an output signal from an encoder.

22. The machine vision system of claim 21 wherein the means for determining a linear velocity of the object from the captured images includes means for locating at least one feature of the object in at least two of the captured images, determining a change of position of the feature between the at least two of the captured images, and determining a time between the capture of the at least two captured images.

23. The machine vision system of claim 21 wherein the means for producing an encoder emulation output signal based on the determined linear velocity produces at least one encoder emulative waveform selected from the group consisting of a single pulse train output waveform and a quadrature output waveform comprising a first pulse train and a second pulse train.

24. The machine vision system of claim 21 wherein means for producing at least one encoder emulative waveform produces a pulse train emulative of an incremental output waveform from an incremental encoder.

25. The machine vision system of claim 21 wherein means for producing an encoder emulation output signal based on the determined linear velocity produces a set of binary words emulative of an absolute output waveform of an absolute encoder.

26. The machine vision system of claim 21 wherein the machine vision system is communicatively coupled to provide the encoder emulation signal to an intermediary transducer communicatively positioned between the machine vision system and a robot controller.

27. The machine vision system of claim 21, further comprising:
at least one actuator physically coupled to move the camera relative to the object based at least in part on at least one of a position, a speed or a velocity of the object with respect to the camera to at least partially avoid an occlusion of a view of the object by the camera.

28. The machine vision system of claim 21, further comprising:
at least one actuator physically coupled to adjust a movement of the object relative to the camera based at least in part on at least one of a position, a speed or a velocity of the object with respect to the camera to at least partially avoid an occlusion of a view of the object by the camera.

29. The machine vision system of claim 21, further comprising:
means for automatically determining at least one of a velocity or an acceleration of the object with respect to a reference frame; and
means for predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera.

30. The machine vision system of claim 21, further comprising:
means for determining at least one other velocity of the object from the captured images; and
means for producing at least one other encoder emulation output signal based on the determined other velocity, the at least one other encoder emulation signal emulative of an output signal from an encoder.

31. The machine vision system of claim 30 wherein means for determining at least one other velocity of the object from the captured images includes software means for determining at least one of an angular velocity or another linear velocity from the images.

32. A computer-readable medium storing instructions for causing a machine vision system to control at least one robot, by:
determining at least one velocity of an object along or about at least a first axis from a plurality of successively captured images of the object; and
producing at least one encoder emulation output signal based on the determined at least one velocity, the encoder emulation signal emulative of an output signal from an encoder.

33. The computer-readable medium of claim 32 wherein producing at least one encoder emulation output signal based on the determined at least one velocity, the encoder emulation signal emulative of an output signal from an encoder includes producing at least one encoder emulative waveform selected from the group consisting of a single pulse train output waveform and a quadrature output waveform comprising a first pulse train and a second pulse train.

34. The computer-readable medium of claim 32 wherein producing at least one encoder emulation output signal based on the determined at least one velocity, the encoder emulation signal emulative of an output signal from an encoder includes producing a set of binary words emulative of an absolute output waveform of an absolute encoder.

35. The computer-readable medium of claim 32 wherein the instructions cause the machine-vision system to further control the at least one robot, by:
predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera.

36. The computer-readable medium of claim 32 wherein the instructions cause the machine-vision system to additionally control movement of the object, by:
adjust a movement of the object relative to the camera based at least in part on at least one of a position, a speed or a velocity of the object with respect to the camera to at least partially avoid an occlusion of a view of the object by the camera.

37. The computer-readable medium of claim 32 wherein the instructions cause the machine-vision system to additionally control the camera, by:
moving the camera relative to the object based at least in part on at least one of a position, a speed or a velocity of the object with respect to the camera to at least partially avoid an occlusion of a view of the object by the camera.

38. The computer-readable medium of claim 32 wherein determining at least one velocity of an object along or about at least a first axis from a plurality of successively captured images of the object includes determining a velocity of the object along or about two different axes from the captured images; and wherein producing at least one other encoder emulation output signal based on the at least one determined velocity includes producing at least two distinct encoder emulation output signals, each of the encoder emulation output signals indicative of the determined velocity about or along a respective one of the axes.

39. A method operating a machine vision system to control at least one robot, the method comprising:
successively capturing images of an object;
determining a first linear velocity of the object from the captured images;
producing a digital output signal based on the determined first linear velocity, the digital output signal indicative of a position and at least one of a velocity and an acceleration; and
providing the digital output signal to a robot controller without the use of an intermediary transducer.

40. The method of claim 39 wherein successively capturing images of an object includes capturing successive images of the object while the object is in motion.

41. The method of claim 39 wherein successively capturing images of an object includes capturing successive images of the object while the object is in motion along a conveyor system.

42. The method of claim 39 wherein determining a first linear velocity of the object from the captured images includes locating at least one feature of the object in at least two of the captured images, determining a change of position of the feature between the at least two of the captured images, and determining a time between the capture of the at least two captured images.

43. The method of claim 39 wherein providing the digital output signal to a robot controller without the use of an intermediary transducer includes providing the digital output signal to the robot controller without the use of an encoder interface card.

44. The method of claim 39, further comprising:
automatically determining a position of the object with respect to the camera based at least in part on the captured images a change in position of the object between at least two of the images; and
moving the camera relative to the object based at least in part on the determined position of the object with respect to the camera.

45. The method of claim 44 wherein moving the camera relative to the object based at least in part on the determined position of the object with respect to the camera includes moving the camera to at least partially avoid an occlusion of a view of the object by the camera.

46. The method of claim 44 wherein moving the camera relative to the object based at least in part on the determined position of the object with respect to the camera includes changing a speed of the object to at least partially avoid an occlusion of a view of the object by the camera.

47. The method of claim 46, further comprising:
automatically determining at least one of a velocity or an acceleration of the object with respect to a reference frame;
predicting an occlusion event based on at least one of a position, a velocity or an acceleration of the object; and wherein moving the camera based at least in part on the determined position of the object with respect to the camera includes moving the camera to at least partially avoid an occlusion of a view of the object by the camera; and
determining at least one of a new position or a new orientation for the camera that at least partially avoids the occlusion.

48. The method of claim 44, further comprising:
determining whether at least one feature object in at least one of the images is occluded; and wherein moving the camera based at least in part on the determined position of the object with respect to the camera includes moving the camera to at least partially avoid the occlusion in a view of the object by the camera; and
determining at least one of a new position or a new orientation for the camera that at least partially avoids the occlusion.

49. The method of claim 39, further comprising:
determining at least a second linear velocity of the object from the captured images, and wherein producing the digital output signal is further based on the determined second linear velocity.

50. The method of claim 39, further comprising:
determining at least one angular velocity of the object from the captured images, and wherein producing the digital output signal is further based on the at least one determined angular velocity.

51. A machine vision system to control at least one robot, the machine vision system comprising:
a camera operable to successively capture images of an object in motion;
means for determining at least a velocity of the object along or about at least one axis from the captured images;
means for producing a digital output signal based on the determined velocity, the digital output signal indicative of a position and at least one of a velocity and an acceleration, wherein the machine vision system is communicatively coupled to provide the digital output signal to a robot controller without the use of an intermediary transducer.

52. The machine vision system of claim 51 wherein means for determining at least a velocity of the object along or about at least one axis from the captured images includes means for determining a first linear velocity along a first axis and means for determining a second linear velocity along a second axis.

53. The machine vision system of claim 51 wherein means for determining at least a velocity of the object along or about at least one axis from the captured images includes means for determining a first angular velocity about a first axis and means for determining a second angular velocity about a second axis.

54. The machine vision system of claim 51 wherein means for determining at least a velocity of the object along or about at least one axis from the captured images includes means for determining a first linear velocity about a first axis and means for determining a first angular velocity about the first axis.

55. The machine vision system of claim 51, further comprising:
means for moving the camera relative to the object based at least in part on at least one of a position, a speed or an acceleration of the object with respect to the camera to at least partially avoid an occlusion of a view of the object by the camera.

56. The machine vision system of claim 51, further comprising:
means for adjusting a movement of the object based at least in part on at least one of a position, a speed or an acceleration of the object with respect to the camera to at least partially avoid an occlusion of a view of the object by the camera.

57. The machine vision system of claim 51, further comprising:
means for predicting an occlusion event based on at least one of a position, a velocity or an acceleration of the object.

58. A computer-readable medium storing instructions to operate a machine vision system to control at least one robot, by:
determining at least a first velocity of an object in motion from a plurality of successively captured images of the object;
producing a digital output signal based on at least the determined first velocity, the digital output signal indicative of at least one of a velocity or an acceleration of the object; and
providing the digital output signal to a robot controller without the use of an intermediary transducer.

59. The computer-readable medium of claim 58 wherein determining at least a first velocity of an object includes a first linear velocity of the object along a first axis, and determining a second linear velocity along a second axis.

60. The computer-readable medium of claim 58 wherein determining at least a first velocity of an object includes determining a first angular velocity about a first axis and determining a second angular velocity about a second axis.

61. The computer-readable medium of claim 58 wherein determining at least a first velocity of an object includes determining a first linear velocity about a first axis and determining a first angular velocity about the first axis.

62. The computer-readable medium of claim 58 wherein the instructions cause the machine vision system to control the at least one robot, by
predicting an occlusion event based on at least one of a position, a velocity or an acceleration of the object.

63. A method operating a machine vision system to control at least one robot, the method comprising:
successively capturing images of an object with a camera that moves independently from at least an end effector portion of the robot;
automatically determining at least a position of the object with respect to the camera based at least in part on the captured images a change in position of the object between at least two of the images; and
moving at least one of the camera or the object based at least in part on the determined position of the object with respect to the camera.

64. The method of claim 63 wherein moving at least one of the camera or the object based at least in part on the determined position of the object with respect to the camera includes moving the camera to track the object as the object moves.

65. The method of claim 63 wherein moving at least one of the camera or the object based at least in part on the determined position of the object with respect to the camera includes moving the camera to track the object as the object moves along a conveyor.

66. The method of claim 63 wherein moving at least one of the camera or object based at least in part on the determined position of the object with respect to the camera includes moving the camera to at least partially avoid an occlusion of a view of the object by the camera.

67. The method of claim 63 wherein moving at least one of the camera or object based at least in part on the determined position of the object with respect to the camera includes adjusting a movement of the object to at least partially avoid an occlusion of a view of the object by the camera.

68. The method of claim 63, further comprising:
automatically determining at least one of a velocity or an acceleration of the object with respect to a reference frame.

69. The method of claim 63, further comprising:
predicting an occlusion event based on at least one of a position, a velocity or an acceleration of the object; and wherein moving at least one of the camera or the object based at least in part on the determined position of the object with respect to the camera includes moving the camera to at least partially avoid an occlusion of a view of the object by the camera.

70. The method of claim 69, further comprising:
determining at least one of a new position or a new orientation for the camera that at least partially avoids the occlusion.

71. The method of claim 63, further comprising:
predicting an occlusion event based on at least one of a position, a velocity or an acceleration of the object; and wherein moving at least one of the camera or the object based at least in part on the determined position of the object with respect to the camera includes adjusting a movement of the object to at least partially avoid an occlusion of a view of the object by the camera.

72. The method of claim 71, further comprising:
determining at least one of at least one of a new position, a new speed, a new acceleration, or a new orientation for the object that at least partially avoids the occlusion.

73. The method of claim 63, further comprising:
determining whether at least one feature of the object in at least one of the images is occluded; and wherein moving the camera based at least in part on the determined position of the object with respect to the camera includes moving the camera to at least partially avoid the occlusion in a view of the object by the camera.

74. The method of claim 73, further comprising:
determining at least one of a new position or a new orientation for the camera that at least partially avoids the occlusion.

75. The method of claim 63 wherein moving at least one of the camera or the object based at least in part on the determined position of the object with respect to the camera includes translating the camera.

76. The method of claim 63 wherein moving at least one of the camera or the object based at least in part on the determined position of the object with respect to the camera includes change a speed at which the camera is translating.

77. The method of claim 63 wherein moving at least one of the camera or the object based at least in part on the determined position of the object with respect to the camera includes pivoting the camera about at least one axis.

78. The method of claim 63 wherein moving at least one of the camera or the object based at least in part on the determined position of the object with respect to the camera includes translating the object.

79. The method of claim 63 wherein moving at least one of the camera or the object based at least in part on the determined position of the object with respect to the camera includes changing a speed at which the object is translating.

80. The method of claim 63 wherein moving at least one of the camera or the object based at least in part on the determined position of the object with respect to the camera includes pivoting the object about at least one axis.

81. The method of claim 63 wherein moving at least one of the camera or the object based at least in part on the determined position of the object with respect to the camera includes changing a speed at which the object is rotating.

82. A machine vision system to control at least one robot, the machine vision system comprising:
a camera operable to successively capture images of an object in motion, the camera mounted;
means for automatically determining at least a position of the object with respect to the camera based at least in part on the captured images a change in position of the object between at least two of the images; and
at least one actuator coupled to move at least one of the camera or the object; and
means for controlling the at least one actuator based at least in part on the determined position of the object with respect to the camera to at least partially avoid an occlusion of a view of the object by the camera.

83. The machine vision system of claim 82, further comprising:
means for predicting an occlusion event based on at least one of a position, a velocity or an acceleration of the object.

84. The machine vision system of claim 83, further comprising:
means for determining at least one of a new position or a new orientation for the camera that at least partially avoids the occlusion.

85. The machine vision system of claim 84 wherein the actuator is physically coupled to move the camera.

86. The machine vision system of claim 83, further comprising:
means for determining at least one of a new position or a new orientation for the object that at least partially avoids the occlusion.

87. The machine vision system of claim 86 wherein the actuator is physically coupled to move the object.

88. The machine vision system of claim 82, further comprising:
means for detecting an occlusion of at least one feature of the object in at least one of the images of the object.

89. The machine vision system of claim 88, further comprising:
means for determining at least one of a new position or a new orientation for the camera that at least partially avoids the occlusion.

90. The machine vision system of claim 89 wherein the actuator is physically coupled to move at least one of translate or rotate the camera.

91. The machine vision system of claim 82, further comprising:
means for determining at least one of a new position or a new orientation for the object that at least partially avoids the occlusion.

92. The machine vision system of claim 91 wherein the actuator is physically coupled to at least one of translate, rotate or adjust a speed of the object.

93. A computer-readable medium storing instructions that cause a machine vision system to control at least one robot, by:
automatically determining at least a position of an object with respect to a camera that moves independently from at least an end effector portion of the robot, based at least in part on a plurality of successively captured images a change in position of the object between at least two of the images; and
causing at least one actuator to move at least one of the camera or the object based at least in part on the determined position of the object with respect to the camera to at least partially avoid an occlusion of a view of the object by the camera.

94. The computer-readable medium of claim 93 wherein causing at least one actuator to move at least one of the camera or the object based at least in part on the determined position of the object with respect to the camera to at least partially avoid an occlusion of a view of the object by the camera includes translating the camera along at least one axis.

95. The computer-readable medium of claim 93 wherein causing at least one actuator to move at least one of the camera or the object based at least in part on the determined position of the object with respect to the camera to at least partially avoid an occlusion of a view of the object by the camera includes rotating the camera about at least one axis.

96. The computer-readable medium of claim 93 wherein causing at least one actuator to move at least one of the camera or the object based at least in part on the determined position of the object with respect to the camera to at least partially avoid an occlusion of a view of the object by the camera includes adjusting a movement of the object.

97. The computer-readable medium of claim 93 wherein adjusting a movement of the object includes adjusting at least one of a linear velocity or rotational velocity of the object.

98. The computer-readable medium of claim 93 wherein the instructions cause the machine vision system to control the at least one robot, further by:
predicting an occlusion event based on at least one of a position, a velocity or an acceleration of the object.

99. The computer-readable medium of claim 93 wherein the instructions cause the machine vision system to control the at least one robot, further by:
determining whether at least one feature of the object in at least one of the images is occluded.

100. The computer-readable medium of claim 93 wherein the instructions cause the machine vision system to control the at least one robot, further by:
determining at least one of a new position or a new orientation for the camera that at least partially avoids the occlusion.

101. The computer-readable medium of claim 93 wherein the instructions cause the machine vision system to control the at least one robot, further by:
determining at least one of a new position, a new orientation, or a new speed for the object which at least partially avoids the occlusion.
